(19) United States
(12) Patent Application Publication
(10) Pub. No.: US 2026/0329895 A1
(43) Pub. Date: Oct. 22, 2026

(54) METHOD, APPARATUS, AND COMPUTER READABLE MEDIUM FOR QUANTITATIVELY GROUPING USING COMPUTATIONAL CLUSTERING

(71) Applicant: KEEP COMPANY, INC., Bethesda, MD (US)

(72) Inventor: Adrienne PRENTICE, Bethesda, MD (US)

(21) Appl. No.: 19/680,508

(22) Filed: May 18, 2026

Related U.S. Application Data
(63) Continuation-in-part of application No. 19/072,337, filed on Mar. 6, 2025, now abandoned.
Application No. 19/072,337 is a continuation of application No. 18/516,108, filed on Nov. 21, 2023, now Pat. No. 12,271,400.
Application No. 18/516,108 is a continuation of application No. 17/829,149, filed on May 31, 2022, now Pat. No. 11,860,908.
(60) Provisional application No. 63/194,402, filed on May 28, 2021.

(51) Int. Cl. G06F 16/28

(52) U.S. Cl. CPC G06F 16/285; G06F 16/283

(57) ABSTRACT

A method, apparatus, and computer-readable medium for quantitatively grouping a set of persons into groups using computational clustering, including storing a set of data objects corresponding to the set of persons and attributes corresponding to each data object in the set of data objects, receiving a selection of a clustering methodology in clustering methodologies via a user interface, each clustering methodology having a corresponding set of attribute weights corresponding to attributes, generating multidimensional objects by encoding each data object as a multidimensional object based on attributes corresponding to that data object, each multidimensional object corresponding to a data object in the set of data objects, and generating groups of data objects based on applying a clustering algorithm to multidimensional objects to generate solution sets and selecting a solution set from solution sets based on the set of attribute weights corresponding to the selected clustering methodology.

### RELATED APPLICATION DATA

This application is a continuation-in-part of U.S. Nonprovisional application Ser. No. 19/072,337, filed Mar. 6, 2025, which is a continuation of U.S. Nonprovisional application Ser. No. 18/516,108, filed Nov. 21, 2023, and issued as U.S. Pat. No. 12,271,400 B2, which is a continuation of U.S. Nonprovisional application Ser. No. 17/829,149, filed May 31, 2022, and issued as U.S. Pat. No. 11,860,908 B2, which itself claims priority to U.S. Provisional Application No. 63/194,402, filed May 28, 2021, the disclosures of which are hereby incorporated by reference in their entirety.

### BACKGROUND

Current ranking and matching systems involving users are typically targeted to matching a user with another user (e.g., for online dating), matching a group of users for particular event (e.g., for meetup groups), or matching the interests of particular user to an activity or product (e.g., for advertisements).

These matching systems are not designed or capable of performing the more sophisticated process of constructing an optimal set of user groups out of a population of users, based upon not only the individual characteristics, attributes, values, and interests of each user, but also the interactions between the attributes and values of users within each group, the overall group dynamic, and the configuration of persons into groups that optimizes results for the maximum number of people.

Accordingly, improvements are needed in systems for quantitatively grouping persons into groups.

### BRIEF DESCRIPTION OF THE DRAWINGS

Current ranking and matching systems involving users are typically targeted to matching a user with another user (e.g., for online dating), matching a group of users for particular event (e.g., for meetup groups), or matching the interests of particular user to an activity or product (e.g., for advertisements).

FIG. 1 illustrates a flowchart for quantitatively grouping a set of persons into a plurality of groups of three or more persons using computational clustering according to an exemplary embodiment.

FIG. 2 illustrates two examples of data objects corresponding to persons and associated attributes according to an exemplary embodiment.

FIG. 3 illustrates an example of encoding data objects as multidimensional objects according to an exemplary embodiment.

FIG. 4 illustrates a flowchart for generating a plurality of groups of three or more data objects based at least in part on applying a clustering algorithm to the multidimensional objects according to an exemplary embodiment.

FIGS. 5A-5C illustrate an example of the clustering process according to an exemplary embodiment.

FIG. 6 illustrates a process for removing solution sets from the plurality of solution sets to generate a filtered plurality of solution sets according to an exemplary embodiment.

FIG. 7 illustrates an example of the process for selecting a solution set from the filtered plurality of solution sets according to an exemplary embodiment.

FIG. 8 illustrates an example of grouping a plurality of data objects according to the plurality of clusters defined in the selected solution set according to an exemplary embodiment.

FIG. 9 illustrates a flowchart for quantitatively grouping a set of persons into a plurality of groups using computational clustering that incorporates multiple different clustering methodologies.

FIGS. 10A-10B illustrate an example of selecting a clustering methodology according to an exemplary embodiment.

FIG. 11 illustrates examples of clustering methodologies and attribute weights according to an exemplary embodiment.

FIG. 12 illustrates a flowchart for generating a plurality of groups of data objects based at least in part on applying a clustering algorithm to the plurality of multidimensional objects to generate a plurality solution sets and selecting a solution set from the plurality of solution sets based at least in part on the set of attribute weights corresponding to the selected clustering methodology according to an exemplary embodiment.

FIG. 13 illustrates another example of the process for selecting a solution set from the filtered plurality of solution sets according to an exemplary embodiment.

FIG. 14 illustrates a flowchart for generating groups using multiple clustering methodologies according to an exemplary embodiment.

FIG. 15 illustrates an interface for selecting multiple clustering methodologies to generate groupings according to an exemplary embodiment.

FIG. 16 illustrates an interface 1600 for updating a gathering algorithm/clustering methodology according to an exemplary embodiment.

FIG. 17 illustrates a flowchart for generating and executing group-specific workflows according to an exemplary embodiment.

FIG. 18 illustrates an interface for selecting a group type and program according to an exemplary embodiment.

FIG. 19 illustrates an example of group types and associated workflows according to an exemplary embodiment.

FIG. 20 illustrates an example of program types and associated workflows according to an exemplary embodiment.

FIG. 21 illustrates a system chart of the clustering and corresponding workflow execution process according to an exemplary embodiment.

FIG. 22 illustrates an example of a group-specific notification interface according to an exemplary embodiment.

FIG. 23 illustrates an interface with different types of events/actions that can be preconfigured for group types according to an exemplary embodiment.

FIG. 24 illustrates an interface showing an example of template message to be sent to group members according to an exemplary embodiment.

FIG. 25 illustrates a flowchart for tracking insights in groups according to an exemplary embodiment.

FIG. 26 illustrates an interface for viewing insights according to an exemplary embodiment.

FIG. 27 illustrates a flowchart for identifying intra-group conflicts according to an exemplary embodiment.

FIG. 28 illustrates an interface for displaying conflicts according to an exemplary embodiment.

FIG. 29 illustrates the components of the specialized computing environment configured to perform the specialized processes described herein.

### DETAILED DESCRIPTION

It is to be understood that at least some of the figures and descriptions of the invention have been simplified to illustrate elements that are relevant for a clear understanding of the invention, while eliminating, for purposes of clarity, other elements that those of ordinary skill in the art will appreciate also comprise a portion of the invention. However, because such elements do not facilitate a better understanding of the invention, a description of such elements is not provided herein.

Applicant has discovered a method, apparatus, and computer-readable medium for quantitatively grouping a set of persons into a plurality of groups of three or more persons using computational clustering that improves computer technology in the field of computational matching and ranking.

Unlike existing matching and ranking technologies, which are some form of a matching process that matches each user with another user or each user with a particular interest or activity, the presently disclosed process is configured to optimize the grouping of persons within a population.

This process is far more computationally complex than simple matching, due to the exponentially increasing number of permutations as the population size increases. For example, given a population of 100 people having certain attributes and requirements, and possible group sizes of 3-10 people, there are a large number of possible groupings of people that would meet the requirements of the population.

Simple matching approaches which are designed to optimize one-to-one matches between users or between users and activities or advertisements cannot be applied to population level grouping problems. This is because these approaches consider each match in isolation, as each match does not have an effect on the overall population of users. These approaches are not applicable to population grouping because they optimize only individual matches for users and do not optimize results for the entire group. By contrast, in population grouping, even if a set of users that have been grouped together are optimally matched, the solution is not an optimal solution if it does not maximize results across all groupings of users from the population.

In an exemplary embodiment, the disclosed method, apparatus, and computer-readable medium for quantitatively grouping a set of persons into a plurality of groups of three or more persons using computational clustering is used to group a population of caregivers or a subset of caregivers (e.g., mothers) into groups or “circles” based on attributes of the population of caregivers. These attributes can be derived based upon, for example, characteristics, values and/or interests of the population and individuals within it. This can aid mothers (or fathers or other caregivers) in finding inclusive, like-minded, and accessible groups of individuals to form support networks and relationships and exchange advice.

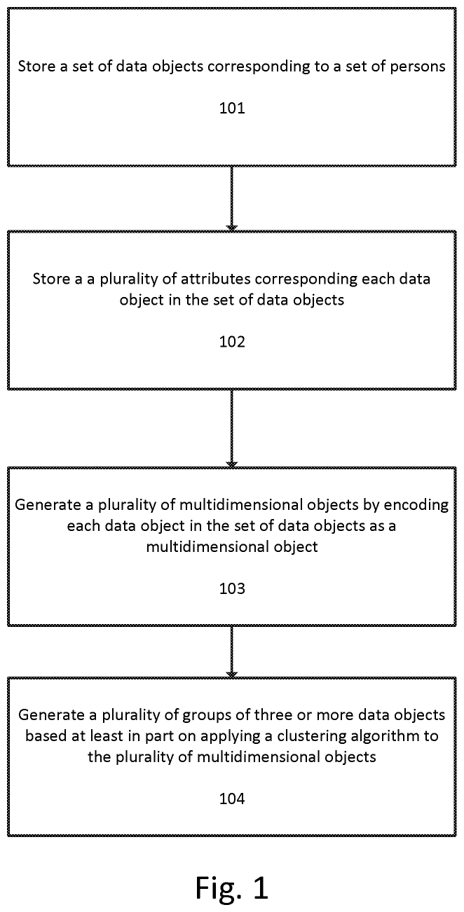

FIG. 1 illustrates a flowchart for quantitatively grouping a set of persons into a plurality of groups of three or more persons using computational clustering according to an exemplary embodiment.

At step 101 a set of data objects corresponding to a set of persons are stored. The data objects can take any suitable form. For example, the data objects can be rows of a person database or table. The data objects can also be objects in an object oriented language, such as a user-defined class, a structure, an array, or some other suitable structure. These examples are provided for illustration only and are not intended to be limiting.

At step 102 a plurality of attributes corresponding to each data object in the set of data objects are stored. Once again, the storage of the attributes can take any suitable form. For example, the attributes can be stored in individual columns of a table or a database, or be stored as variables within a specialized person data object, such as a person struct object. Many variations are possible.

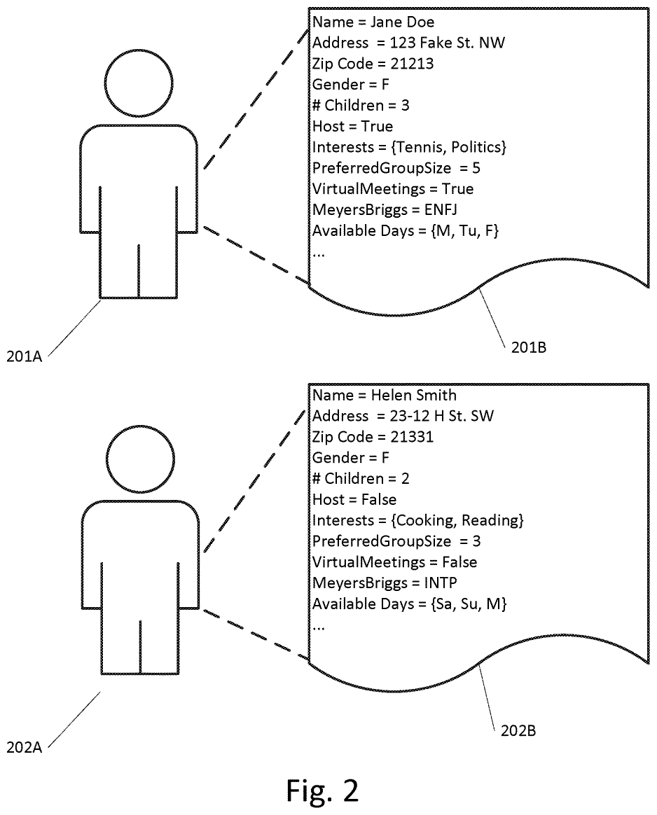

FIG. 2 illustrates two examples of data objects corresponding to persons and associated attributes according to an exemplary embodiment. Data object 201B corresponds to person 201A and data object 202B corresponds to person 202A. As shown in FIG. 2, each of the data objects includes a plurality of attributes. The attributes can be stored as variables within the data objects. For example, the Name attribute and the Address attribute can be stored as string variables, the Number of Children attribute can be stored as an integer, and the Host attribute and VirtualMeetings attribute (explained below) can be stored as Boolean values. In another example, the Interests attribute can be stored as an array of strings or as a single sting. Many variations are possible and these examples are not intended to be limiting.

The values of the attributes can be provided directly by users through a user interface. For example, the Name, Address, Zip Code, and Gender attributes can be entered by a user through a user interface when the user signs up for the group matching service.

The values of the attributes can also be automatically generated or derived from information provided by the user through a user interface. For example, a user may be asked to answer a set of personality questions, resulting in a Myers-Briggs personality type being assigned to the user in a MeyersBriggs attribute. In another example, the attributes can be generated or derived based on answers to an assessment, such as the well-being assessment shown below.

| | Survey Question |
|---|---|
| | Answers offered on sliding 5-point scale. |
| Behavior | Questions asked in Circle registration form and in post-program |
| Change/Outcome | survey. |
| Take better care of | 1. I take care of my mental health, including paying attention to |
| themselves mentally & | how I am feeling and processing my emotions. [Never → |
| physically | Always] |
| | 2. I nurture my physical body, including getting adequate sleep, |
| | healthy food & body movement. [Never → Always] |
| | 3. I devote meaningful time to my personal interests and hobbies. |
| | [Never → Always] |
| Act with more | 4. I am a good mom. [Never → Always] |
| confidence, presence and | 5. I am a good employee. [Never → Always] |
| intention (home & office) | 6. I take my own values, goals and intuition into account when |
| | making decisions. [Never → Always] |
| Ask for help (home & | 7. I ask for help when I need it. |
| office) | At work: [Never → Always] |
| | At home: [Never → Always] |
| Cope with stress better | 8. My coping strategies in stressful times are: [Terrible → |
| | Excellent]. |
| Feel more in control | 9. I feel stuck or unable to progress. |
| | At work: [Never → Always] |
| | At home: [Never → Always] |
| Feel more belonging, | 10. I feel connected to myself; I know who I am. [Not at all → |
| connection & community | Completely] |
| (home & office) | 11. I feel like I can bring my whole self (all aspects of me, |
| | including my Motherhood) to work. [Not at all → Completely] |
| | 12. I feel lonely in my daily life. [Never → Always] |
| | 13. I have a community that provides emotional support and |
| | motivation. [Not at all → Completely] |
| Loyal to employer | 14. I consider exiting the workforce or reducing my hours. [Never - |
| (retention) | Monthly - Daily] |
| Communicate more | 15. I supportively listen to others. [Never → Always] |
| effectively | 16. I clearly communicate with others. [Never → Always] |
| More productive | 17. I work smart: I use systems to evaluate and prioritize my |
| | responsibilities and keep clear boundaries to reinforce my efforts. |
| | At work: [Never → Always] |
| | At home: [Never → Always] |

Other questions that can be used to derive attributes can include questions about group dynamics (e.g., “how comfortable are you sharing with a group?”), questions about readiness for change/growth (e.g., “are you open to trying new things?), questions about how participants feel at work, and/or questions about inclusivity and belonging.

Other examples of generated or derived attributes include distance based metrics. For example, a user can provide an address and the system can utilize a Global Positioning System and/or map databases to determine a distance from the user's residence to the nearest playground. This may be a relevant attribute when forming groups of mothers, as discussed earlier.

Other attributes can be Boolean (true/false) attributes indicating a user's preferences or answers to questions. For example, in the case of forming groups of mothers, each mother can be asked whether she can act as a host for the other mothers and their children. If the mother can act as a host, then the Host attribute can be set to true, otherwise it is set to false. Each mother can also be asked whether she is available for virtual meetings (e.g., via videoconferencing/teleconferencing software). This attribute can also be stored as true/false value.

The attributes corresponding to each data object can include, for example, a name, an address, a zip code, a quantity of children, a gender, a gender of a child, an interest, a hobby, a preferred group size, an indicator of hosting ability, an indicator of virtual communications ability, a personality indicator, a maximum travel distance, a transportation means, an availability attribute, an age of a child or children, an experience type (i.e., blended families, raising special needs kids, first time mom over 40, etc.), race, a well-being indicator (i.e., resulting from an assessment both pre-grouping and post-grouping], a goal (i.e., caregivers can be asked why they are joining a Circle/group with multiple choice answers including community, friendship, accountability, personal growth, empathy, parenting resources, etc.), household income, employment status, profession, role and/or function (i.e., entry-level employees, mid-level, executives), caregiving responsibilities (i.e., who the caregiver cares for, that person's condition, etc.), matching preferences for whether participant prefers to match with moms, dads, any parents (mother or father), or any caregivers (e.g., grandparents, nannies, or other caregivers).

The maximum travel distance attribute can indicate the maximum distance the user is willing to travel to meet with the group. The transportation means attribute can indicate, for example, different means of transportation available to the user (e.g., bus, car, train, etc.).

As shown in FIG. 2, the availability attribute can be a listing of available days for each person. A second availability attribute can also be utilized to indicate available time slots or time periods within each day.

A PreferredGroupSize attribute can be used to store the preferred group size for each person. This value can be entered by the user during registration and/or as part of the process of being assigned to a group. For example, some mothers may wish to have large groups of people and other mothers may be more introverted and wish to have more intimate groups.

In addition to all the attributes shown in FIG. 2 and discussed above, a second set of attributes can be stored corresponding to at least some of the above-mentioned attributes that indicate a weight or rank of a corresponding attribute. This weight or rank or importance can be entered by a user in a user interface when providing the attribute information or information that is used to derive attributes.

Using the above example of preferred group size, a user can enter a preferred group size and also enter a weight, rank, or importance to be associated with their selected preferred group size. For example, one or more attributes or input fields within the interface can have an associated “importance” indicator or input option. The importance indictor can allow a user select an importance level of the particular attribute (e.g., from 1-10). In another example, a user can rank one or more attributes in order of importance. For example, a user may rank the #Children attribute 1^{st}, indicating that it is most important to them to be grouped with others who have the same number of children, the maximum distance attribute 2^{nd}, and the preferred group size attribute 3^{rd}.

Returning to FIG. 1, at step 103 a plurality of multidimensional objects are generated by encoding each data object in the set of data objects as a multidimensional object based at least in part on two or more attributes corresponding to that data object, with each multidimensional object corresponding to a data object in the set of data objects. As explained further below, the multidimensional objects are utilized to generate multiple solution sets with different groupings (clusters) of users/data objects.

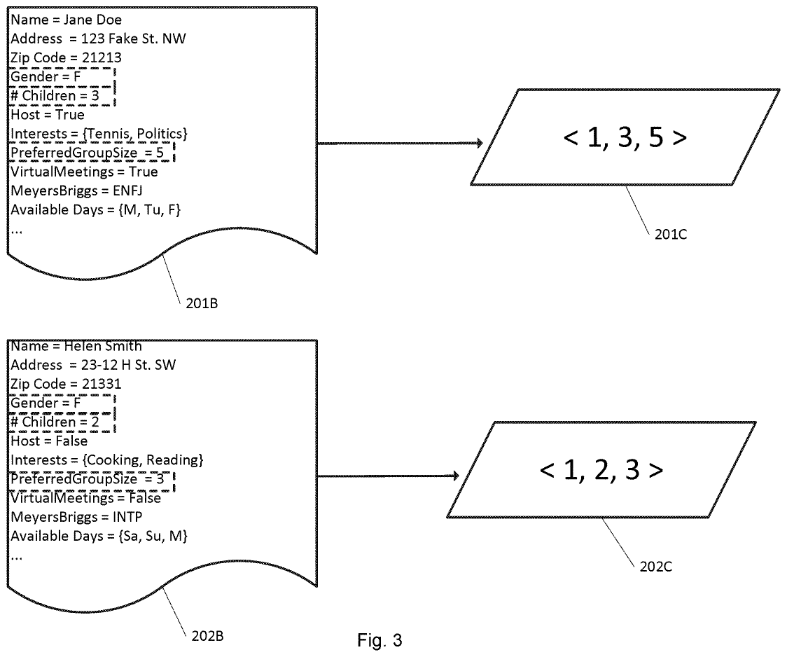

FIG. 3 illustrates an example of encoding data objects as multidimensional objects according to an exemplary embodiment. As shown in FIG. 3, three attributes of each data object, 201B and 202B are used to generate multidimensional objects 201C and 202C. Note that the quantity and selection of attributes used to generate the multidimensional objects can be user-configured and/or set to some default value and more or less attributes or different attributes can be utilized. Each multidimensional object, in this case, is a three-dimensional value with one dimension corresponding to gender (which is represented as a Boolean in this example, with female corresponding to “1”), one dimension corresponding to the #Children attribute, and one dimension corresponding to the PreferredGroupSize attribute. Of course, other attributes can be represented in the multidimensional object in addition to or in place of these attributes.

As shown in FIG. 3, the step of generating a plurality of multidimensional objects by encoding each data object in the set of data objects as a multidimensional object based at least in part on two or more attributes corresponding to that data object includes mapping a value of each attribute in the two or more attributes to a different dimension of the multidimensional object, each dimension corresponding to a range of possible values of the mapped attribute.

Returning to FIG. 1, at step 104 a plurality of groups of three or more data objects are generated based at least in part on applying a clustering algorithm to the multidimensional objects. The clustering algorithm can be any suitable clustering algorithm, such as k-means clustering.

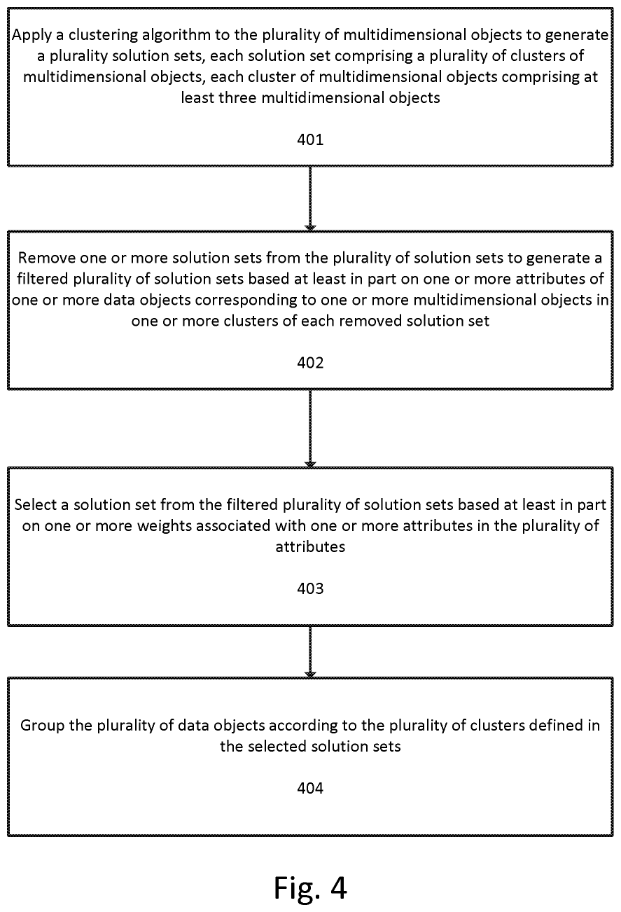

FIG. 4 illustrates a flowchart for generating a plurality of groups of three or more data objects based at least in part on applying a clustering algorithm to the multidimensional objects according to an exemplary embodiment. Optionally, prior to performing the steps shown in FIG. 4, a pre-filtering or pre-sorting step can be applied to all multidimensional objects. For example, the MD objects can be sorted into groups based upon zip code and then the steps shown in FIG. 4 can be performed for each group. In this case, the step of generating the plurality of groups of three or more data objects based at least in part on applying a clustering algorithm to the plurality of multidimensional objects includes grouping the plurality of multidimensional objects into a plurality of multidimensional object groups based on one or more values of one or more dimensions of each multidimensional object. Steps 401-404 of FIG. 4 (described below) would then be performed for each multidimensional object group in the plurality of multidimensional object groups. The dimension(s) used for grouping can include zip code dimension, as indicated above, and/or other dimensions, such as a caregiver type matching preference (e.g., moms only, dads only, both, or other).

At step 401 the clustering algorithm is applied to the plurality of multidimensional objects to generate a plurality solution sets, each solution set comprising a plurality of clusters of multidimensional objects, each cluster of multidimensional objects comprising at least three multidimensional objects. Of course, the clustering algorithm can be configured such that each cluster of multidimensional objects comprises at least two multidimensional objects or such that each cluster of multidimensional objects comprises at least four or more multidimensional objects. A user configured parameter can be used to adjust the minimum quantity of multidimensional objects per cluster.

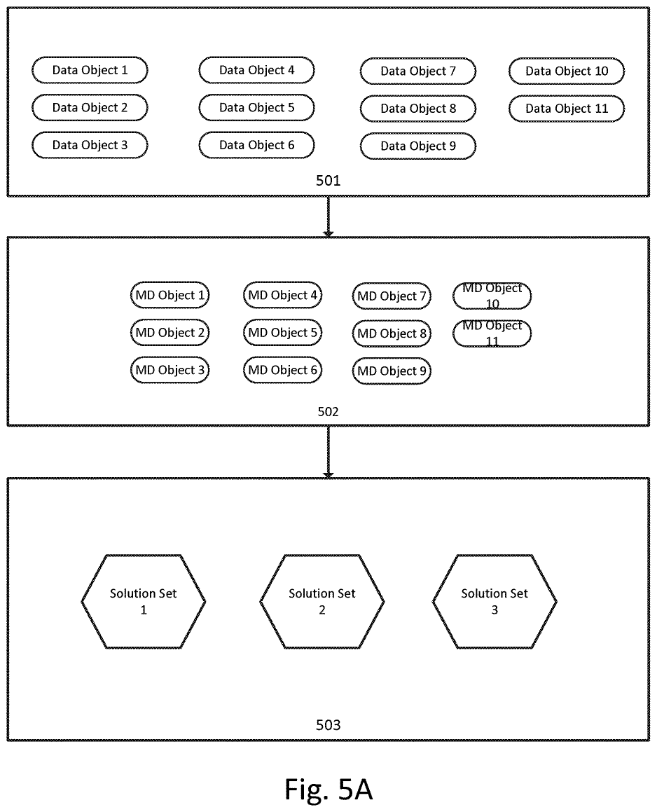

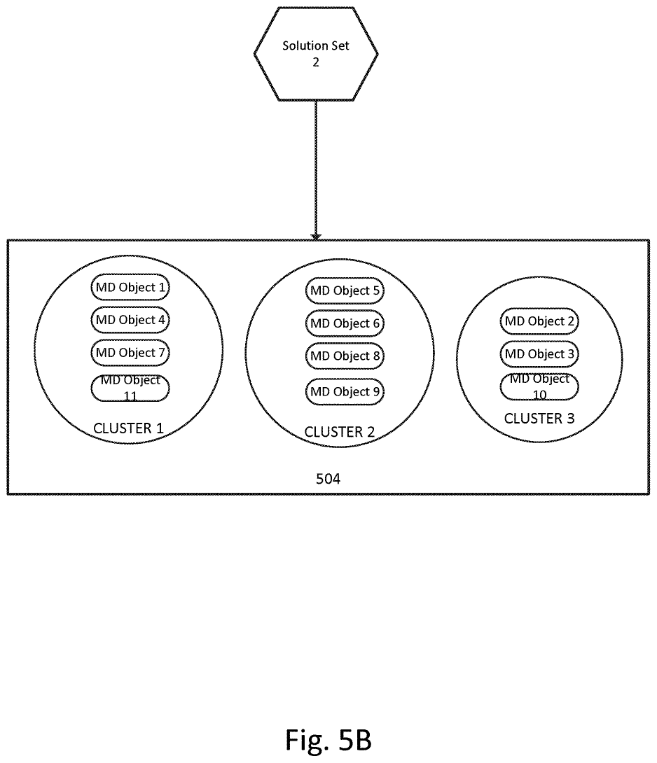

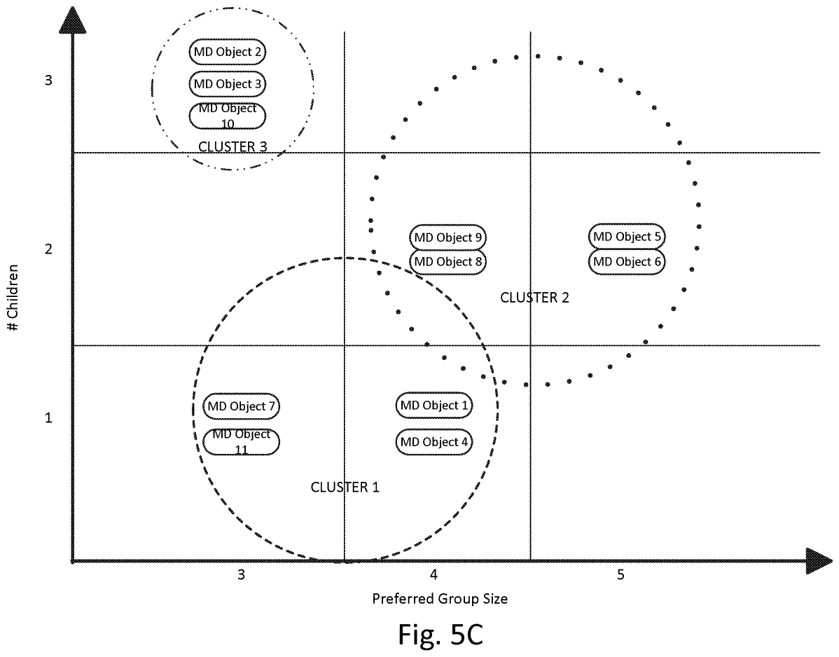

FIGS. 5A-5C illustrate an example of the clustering process according to an exemplary embodiment. As shown in FIG. 5A, a set of data objects 501 are used to generate a plurality of multidimensional objects (“MD objects”) 502, with each MD object corresponding to a particular data object. This process is described earlier. A clustering algorithm is then applied to the plurality of MD objects 502 to generate a plurality of solution sets 503, with each solution set comprising a plurality of clusters of multidimensional objects, each cluster of multidimensional objects comprising at least three multidimensional objects.

The clustering step clusters the MD objects into clusters based upon the distance between each MD object and all other MD objects in the multidimensional space of the MD objects. For example, if the MD objects are two-dimensional, then the clustering algorithm groups MD objects into clusters based on an assessment of distances between each MD object and other MD objects in two dimensional space.

As discussed earlier, clustering can be performed using K-means clustering. Clustering of MD objects can also be performed using the Balanced Iterative Reducing and Clustering using Hierarchies (“BIRCH”) method to cluster the input data objects. BIRCH is a robust clustering algorithm developed for analyzing large volumes of multivariate data. The algorithm is capable of ingesting input data in a continuous fashion. The clustering step when using BIRCH includes four steps, described below.

The first step is building a Clustering Feature (“CF”) tree—during this stage input data is loaded into a B-tree like structure and data objects are agglomerated in the leaf nodes based on relative Euclidean distance between the data objects. Data objects merging threshold is an input parameter of the BIRCH algorithm and is set initially to a small value. When the input data is normalized to the [0, 1] interval, a relatively small merging threshold value, such as 0.0001 can be used. Additionally, as discussed below, the threshold value can be automatically corrected during a subsequent intermediate step.

The second step is CF tree condensing—this operation can be triggered when the CF tree exceeds a preset size. At this time the samples merging threshold can be recomputed and the CF tree can be rebuilt. A new value of the merging threshold can then be derived from the distance between entries in the existing CF tree.

The third step is global clustering—at this step the BIRCH clustering algorithm applies a regular clustering algorithm to information collected in the CF tree. For example, the BIRCH algorithm implementation can utilize two global clustering options: CF tree refinement and Hierarchical Clustering (“HC”). While HC is capable of producing finer granularity clusters, its run time is significantly longer and memory consumption is significantly higher than that of the CF tree refinement procedure.

The fourth step is cluster matching—during this step input data objects are matched with the clusters produced after the refinement step.

As explained previously, while the BIRCH algorithm is described above step, clustering methods other than BIRCH can be used during the clustering step. For example, clustering algorithms such as DBSCAN or K-means can be used to group the MD objects into clusters.

FIG. 5B illustrates one solution set, Solution Set 2, and the plurality of clusters 504 within that solution set according to an exemplary embodiment. As shown in FIG. 5B, the total number of clusters in this particular solution is three, with Cluster 1 having four MD objects, Cluster 2 having four MD objects, and Cluster 3 having three MD objects.

FIG. 5C illustrates a visualization of the clusters of Solution Set 2 in multidimensional space according to an exemplary embodiment. For the purposes of explanation and visualization, the multidimensional space is shown as a two dimensional space, with a first dimension corresponding to a #Children attribute and a second dimension corresponding to a Preferred Group Size attribute. Of course, the actual dimensionality of each MD object and the number of dimensions utilized when the clustering is performed can be greater than two.

Returning to FIG. 4, at step 402 one or more solution sets are removed from the plurality of solution sets to generate a filtered plurality of solution sets based at least in part on one or more attributes of one or more data objects corresponding to one or more multidimensional objects in one or more clusters of each removed solution set.

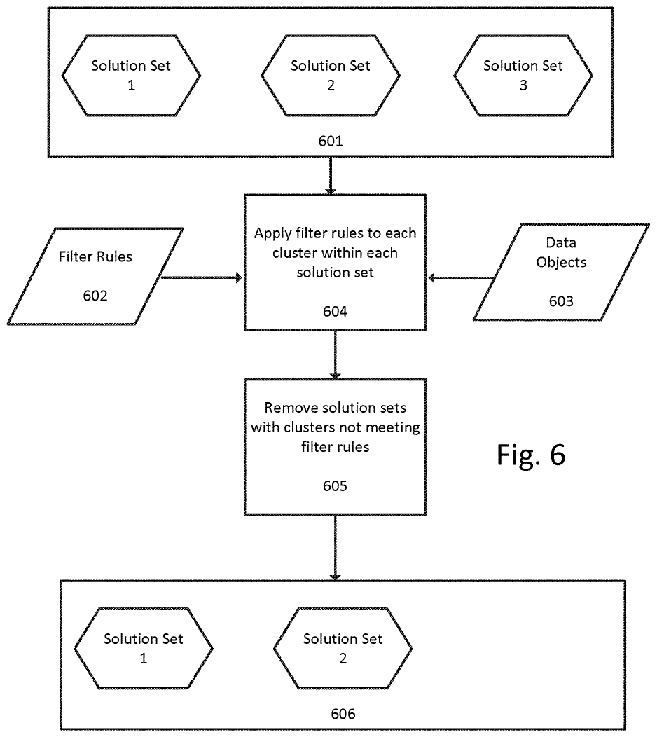

FIG. 6 illustrates a process for removing solution sets from the plurality of solution sets to generate a filtered plurality of solution sets according to an exemplary embodiment. Filter rules 602 and data objects 603 (including the associated attributes) are provided as input to a step of applying filter rules to each cluster within each solution set. The filter rules can include, for example, filtering out a solution set if a cluster size within that solution set deviates too greatly from a preferred group size of the persons within that cluster (i.e., the persons corresponding to the data objects that correspond to the MD objects), filtering out a solution set if a cluster size within that solution set exceeds a predefined threshold or is less than a predefined threshold, filtering out a solution set if a cluster within that solution set does not have any persons that are willing to host, filtering out a solution set if a cluster within that solution set has an incompatibility between attributes of persons in that cluster (e.g., an availability attribute, an ability to have virtual meetings, an available days attribute, etc.), and/or filtering out a solution set if a cluster within that solution set has too great of a distance between persons in that cluster or between one or more persons and a host.

The filtering step 604 is applied to the solutions sets 601 to identify solution sets for removal, which are then removed at step 605. As shown in box 606, this process results in the removal of solution set 3.

Returning to FIG. 4, at step 403 a solution set is selected from the filtered plurality of solution sets based at least in part on one or more weights associated with one or more attributes in the plurality of attributes.

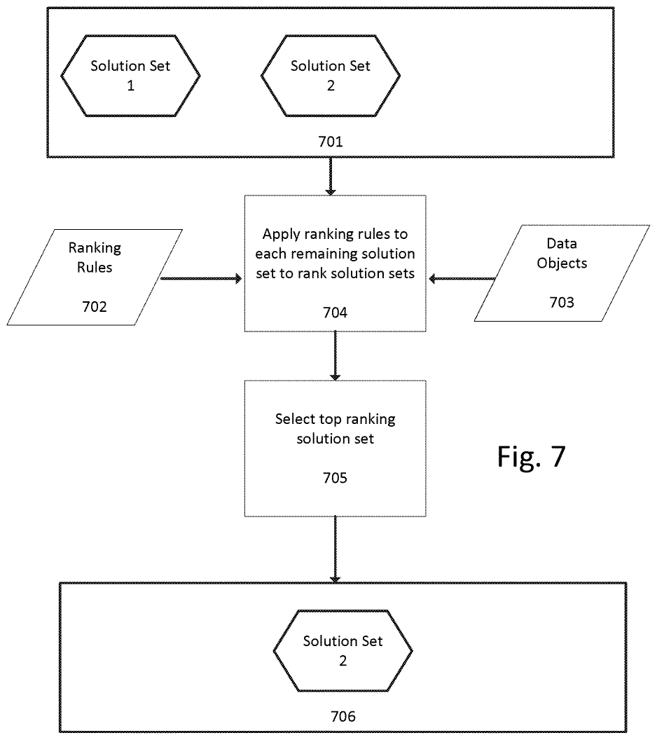

FIG. 7 illustrates an example of the process for selecting a solution set from the filtered plurality of solution sets according to an exemplary embodiment. As shown in FIG. 7, a step of applying ranking rules 704 to each remaining solution set to rank the solution sets is applied to the remaining solutions sets 701. This step takes as input ranking rules 702 and data objects 703 (including the plurality of attributes).

In step 704, the ranking rules are used to assign weights to particular attributes of clusters, of MD objects within clusters, or to solution sets. For example, a solution set that has clusters in which persons are, on average, closer to one another than clusters in other solution sets may be assigned a higher weighting and consequently a higher ranking. Weights and ranks can also be assigned on how well the characteristics of each cluster match the desired attributes of the persons within each cluster. For example, whether a cluster size is equal to the desired group size of all persons within that cluster or whether the number of children of all persons within a cluster matches. Many variations are possible, and these examples are not intended to be limiting.

The ultimate solution set weight and rank can be computed based on some aggregation of weights and ranks of clusters within each solution set, for example an average, a median, or a sum of clusters within each solution set. Many variations are possible, and these examples are not intended to be limiting.

The ranking rules and associated weights can be dynamic, changing in response to user feedback, user assessments, or other feedback from the system. For example, a post-grouping/post-circle assessment can be performed for all individuals that have been grouped and used adjust, remove, or add new ranking rules. An assessment, such as the well-being assessment discussed earlier, can serve a benchmark used to evaluate effectiveness and benefit of the groupings. By measuring well-being prior to and after grouping, the system can determine a “return on investment” or improvement to each member's wellbeing. The groups which result in the greatest improvement to well-being (e.g., improvement above a predetermined threshold) can then be analyzed to determine commonalities between the members, attributes of the individual members and of the group as a whole, and statistical characteristics of the clusters and clustering process used to create the groups. The result of this analysis can then be used to adjust the ranking rules and weightings to select for groups which have the desired attributes and create groups in the future with a higher likelihood of improving well-being. The ranking rules and weightings can therefore be based upon a feedback loop from previous successful groups, as well as each user's own weightings.

The system can identify criteria for optimal group selection using the above-described feedback loop to measure characteristics and attributes (individual, interpersonal, and/or aggregate across members of the group) of successful groups. For example, the system can determine that optimal success of a group (as measured, for example, by improvement in well-being scores) occurs when one or more of the following criteria are met: (1) the average wellbeing score of the group is above some threshold value, (2) the members of the group have a certain mix or distribution of attributes or demographics, (3) the age gap or age range between children of participating moms does not exceed a maximum number of months, and/or (4) the ratio of certain Meyers-Briggs personality types to other Meyers-Briggs personality types matches a predetermined ratio known to produce optimal results or the distribution of Meyers-Briggs personality types matches an ideal distribution for optimal results.

After applying 704 the ranking rules 702, a top ranking solution set is selected at step 705. In this example, the top ranking solution is Solution Set 2, as shown in box 706.

Returning to FIG. 4, at step 404 the plurality of data objects are grouped according to the plurality of clusters defined in the selected solution set. This step includes identifying the data objects corresponding to MD objects within each cluster of the selected solution set and grouping the identified data objects together as a group.

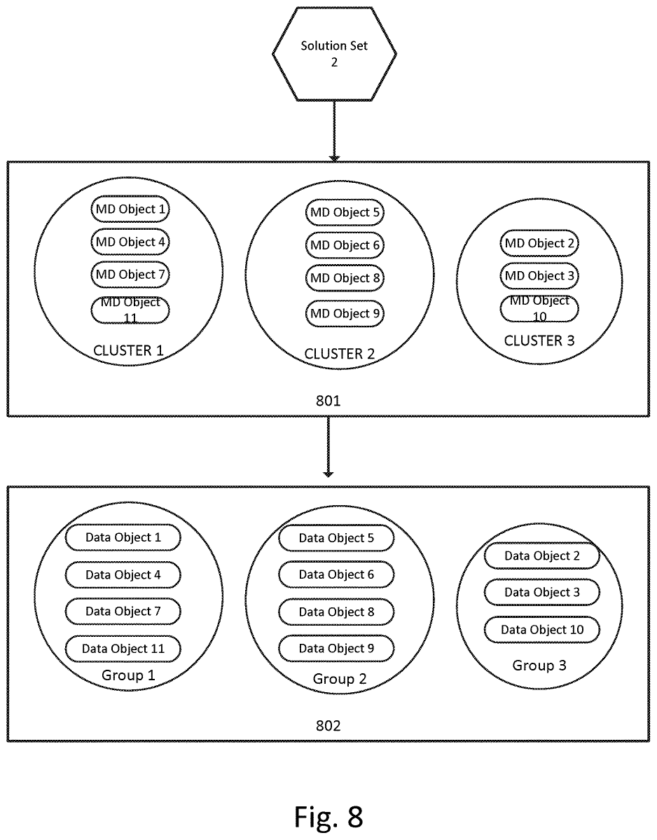

FIG. 8 illustrates an example of grouping a plurality of data objects according to the plurality of clusters defined in the selected solution set according to an exemplary embodiment. As shown in FIG. 8, the selected solution set is Solution Set 2, which includes the clusters shown in box 801. The objects corresponding the MD objects in each cluster are grouped together in groups that correspond to the clusters, as shown in box 802.

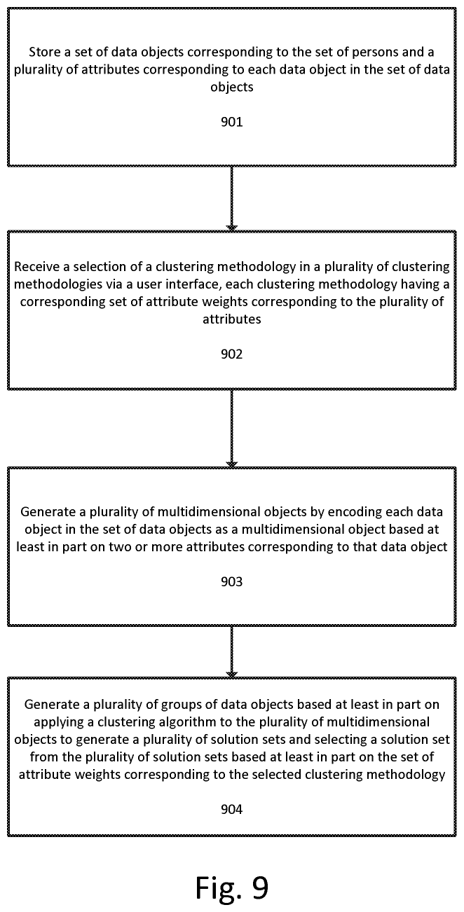

The present techniques for computational clustering can be customized for different types of groups and different clustering methodologies. FIG. 9 illustrates a flowchart for quantitatively grouping a set of persons into a plurality of groups using computational clustering that incorporates multiple different clustering methodologies. The steps shown in FIG. 9 can be executed by one or more computing devices of the clustering platform. The techniques shown in FIGS. 1 and 9 can optionally be utilized in a workplace context to form groups of employees, mentor/mentee pairings, or other types of groups. The plurality of groups can be groups of three or more persons. The plurality of groups can also be groups of two people, such as in a mentor/mentee grouping scenario. The groups can also have mixed sizes, such that some groups are two persons and other groups are greater than two persons.

At step 901 a set of data objects corresponding to the set of persons and a plurality of attributes corresponding to each data object in the set of data objects are stored. This step is similar to steps 101 and 102 described earlier with respect to FIG. 1. Similar to step 101, the data objects can take any suitable form, such as rows of a person database or table or objects in an object oriented language, such as a user-defined class, a structure, an array, or some other suitable structure. Similar to step 102, the storage of the attributes can take any suitable form, such as individual columns of a table or a database, or variables within a specialized person data object, such as a person struct object. Many variations are possible.

At step 902 a selection of a clustering methodology in a plurality of clustering methodologies is received via a user interface, each clustering methodology having a corresponding set of attribute weights corresponding to the plurality of attributes. The attributes can include any of the attributes shown in FIG. 2, any of the parent or caregiver attributes previously described, and can also include a variety of attributes relating to employment and workplace, professional attributes, or other factors. For example, the plurality of attributes can include work department, job title, affinity or demographic groups, parent and caregiver status, availability, office location, law firm practice group, employee seniority, year, or class level, or other attributes.

Attributes can also correspond to relationships between persons, such as persons in a proposed group and/or criteria for the generated groups. For example, an attribute of a group can be the discrepancy in seniority between members, a variety of practice groups represented, or other attributes that measure a collective state of a group. These attributes can be useful when creating certain types of groups, such as mentor/mentee groups meant to pair a senior employee with a junior employee, and integration groups meant to expose employees in different departments/practice groups to each other.

The attribute weights can indicate the importance that is assigned to each of the attributes. Attribute weights are similar to the importance rankings discussed previously, and allow for different types of groups to be generated from different clustering methodologies.

Each clustering methodology can also have a corresponding set of rules that impact the computational clustering performed during the clustering process. Certain clustering methodologies can require certain combinations of group members in each formed group, in terms of attributes of the group members, and the corresponding rules can be utilized to enforce these requirements. For example, a mentor/mentee group can have a corresponding rule requiring that a first member has a seniority level above a first predetermined threshold and that a second member has a seniority level below a predetermined threshold. The rule can also specify a weight to assign of each of these seniority level attributes (e.g., it may be more important to have a senior employee than a very junior employee). Many variations of rules are possible and these examples are not intended to be limiting.

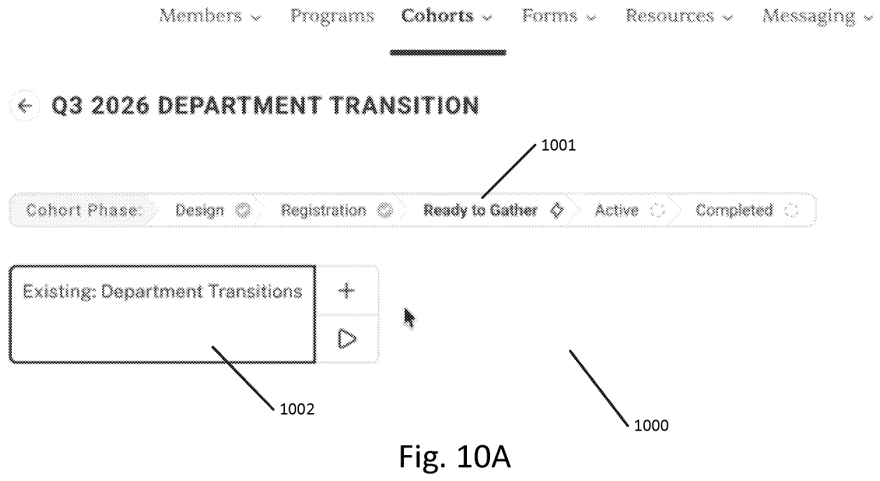

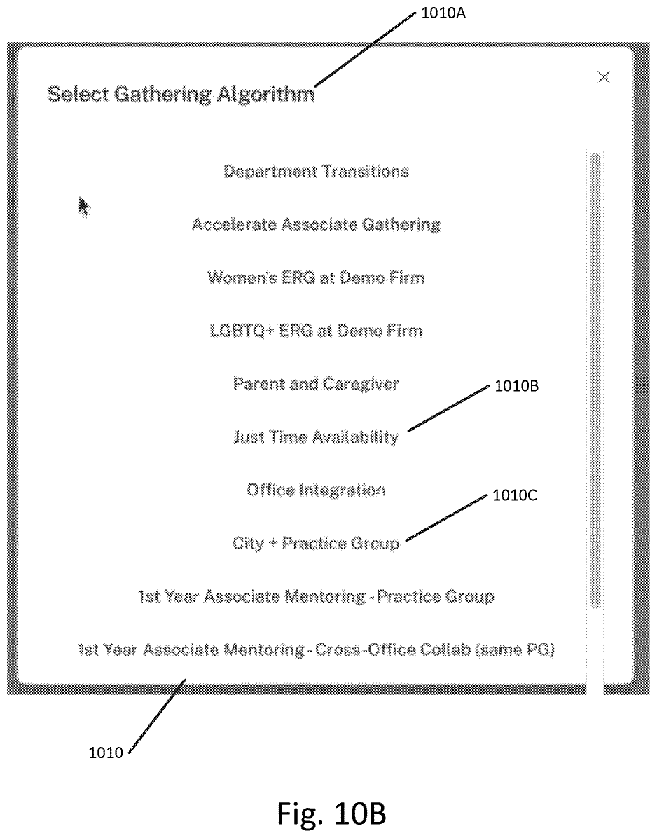

FIGS. 10A-10B illustrate an example of selecting a clustering methodology according to an exemplary embodiment. FIG. 10A illustrates a user interface 1000 for receiving a selection of a clustering methodology. In the example user interface 1000, the clustering process is also referred to herein as “gathering,” as shown by element 1001. As shown in FIG. 10A, the existing clustering methodology that is selected is the “Existing: Department Transitions” 1002 clustering methodology. This clustering methodology can be configured to group persons who have recently transitioned departments with other persons in those departments and can include one or more rules and and/or attribute weights that, when input to and/or applied by the clustering process, generate the desired groupings.

FIG. 10B illustrates an interface showing different selectable clustering methodologies according to an exemplary embodiment. The interface 1010 can be shown when a user selects an existing clustering methodology/gathering algorithm and allows them to select a different gathering algorithm/clustering methodology, as shown at 1010A. The clustering methodologies shown in FIG. 10B are for the purpose of illustration and the system can utilize a variety of additional clustering methodologies (not shown). As shown in FIG. 10B, the clustering methodologies include a Just Time Availability 1010B clustering methodology that prioritizes grouping persons into groups based solely on time availability. The clustering methodologies also include a City+Practice Group 1010C clustering methodology that prioritizes both the city attributes and practice group attributes of the persons being grouped. This clustering methodology can be configured to create groups of persons within the same practice group and city location.

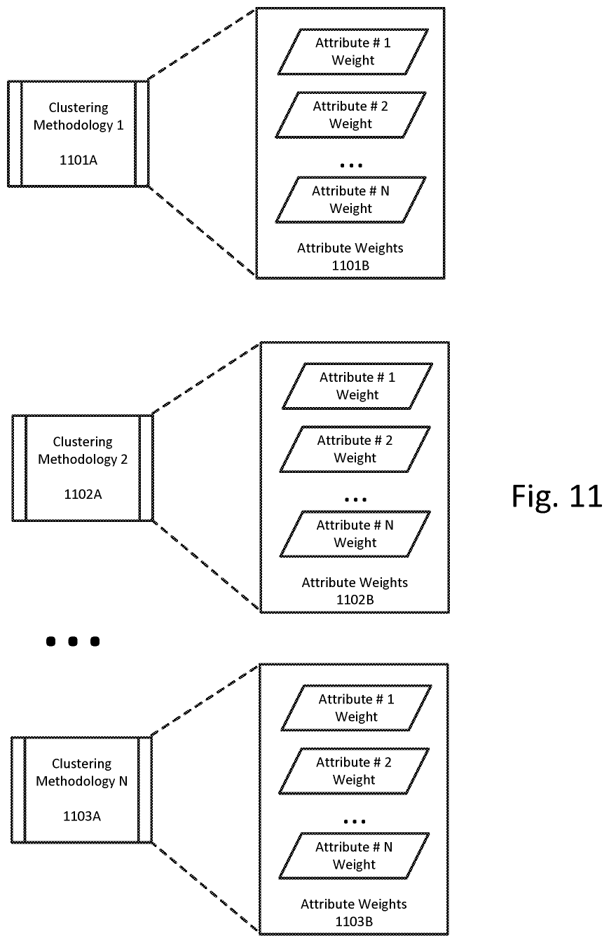

FIG. 11 illustrates examples of clustering methodologies and attribute weights according to an exemplary embodiment. As shown in in FIG. 11, each clustering methodology has a corresponding set of attribute weights. Specifically, clustering methodology 1 1101A has corresponding attribute weights 1101B, clustering methodology 2 1102A has corresponding attribute weights 1102B, and clustering methodology N 1103A has corresponding attribute weights 1103B, where N can be any positive number greater than two (e.g., N=3, 4, 5 . . . etc.). Although not shown, each clustering methodology can also have one or more associated rules that inform the clustering process and are configured to impact the composition of the groups generated by the clustering process.

Returning to FIG. 9, at step 903 a plurality of multidimensional objects are generated by encoding each data object in the set of data objects as a multidimensional object based at least in part on two or more attributes corresponding to that data object, each multidimensional object corresponding to a data object in the set of data objects. This step is similar to step 103 of FIG. 1, described previously, and that description applies to step 903, as similar processes can be used to generate the plurality of multidimensional objects in step 903.

At step 904 a plurality of groups of data objects are generated based at least in part on applying a clustering algorithm to the plurality of multidimensional objects to generate a plurality of solution sets and selecting a solution set from the plurality of solution sets based at least in part on the set of attribute weights corresponding to the selected clustering methodology.

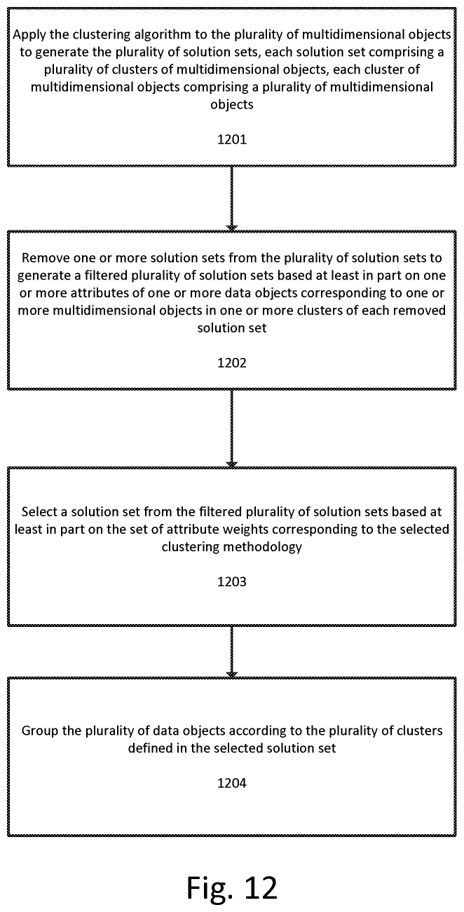

FIG. 12 illustrates a flowchart for generating a plurality of groups of data objects based at least in part on applying a clustering algorithm to the plurality of multidimensional objects to generate a plurality solution sets and selecting a solution set from the plurality of solution sets based at least in part on the set of attribute weights corresponding to the selected clustering methodology according to an exemplary embodiment.

At step 1201 the clustering algorithm is applied to the plurality of multidimensional objects to generate the plurality of solution sets, each solution set comprising a plurality of clusters of multidimensional objects, each cluster of multidimensional objects comprising a plurality of multidimensional objects.

At step 1202 one or more solution sets are removed from the plurality of solution sets to generate a filtered plurality of solution sets based at least in part on one or more attributes of one or more data objects corresponding to one or more multidimensional objects in one or more clusters of each removed solution set.

At step 1203 a solution set is selected from the filtered plurality of solution sets based at least in part on the set of attribute weights corresponding to the selected clustering methodology.

At step 1204 the plurality of data objects are grouped according to the plurality of clusters defined in the selected solution set.

Steps 1201-1204 are similar to steps 401-404, respectively, described previously with respect to FIG. 4 and the description of steps 401-404 also applies to steps 1201-1204. Step 1203 differs from step 403 in that the solution set that is selected from the filtered plurality of solution sets is based at least in part on the set of attribute weights corresponding to the selected clustering methodology.

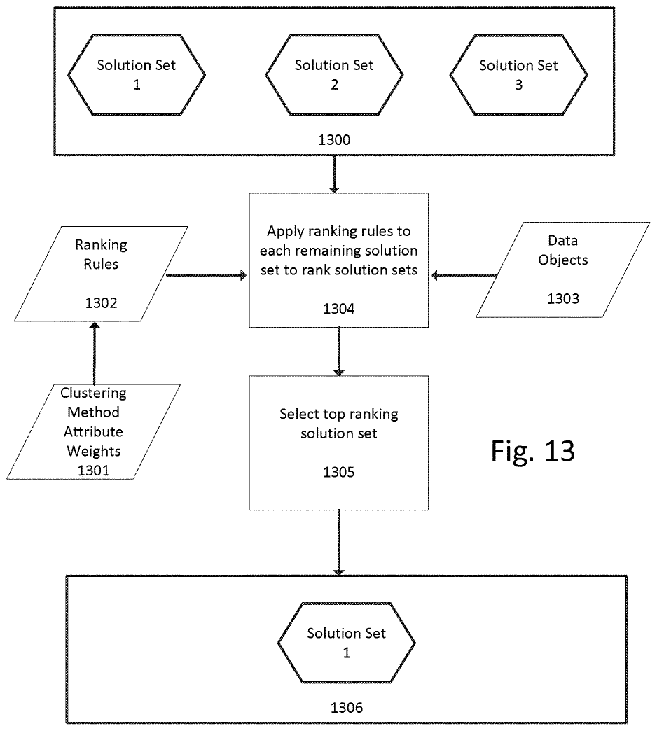

FIG. 13 illustrates another example of the process for selecting a solution set from the filtered plurality of solution sets according to an exemplary embodiment. As shown in FIG. 13, the plurality of solution sets 1300 include Solution Sets 1-3 and the attribute weights 1301 corresponding to the selected clustering methodology are utilized to determine the ranking rules 1302. The ranking rules 1302 are input, along with the data objects 1303 corresponding to persons, to step 1304, which applies the ranking rules to each remaining (i.e., not filtered) solution set to rank the solution sets. At step 1305 the top ranking solution set is selected. In this case, the top ranking solution set 1306 is Solution Set 1. The groupings in Solution Set 1 can then be applied to data objects 1303.

The clustering methodologies disclosed herein can also be combined to selectively narrow the criteria for person groupings. For example, the clustering platform can apply more than one clustering methodology at the same time, or sequentially, to generate groupings that satisfy multiple clustering methodologies.

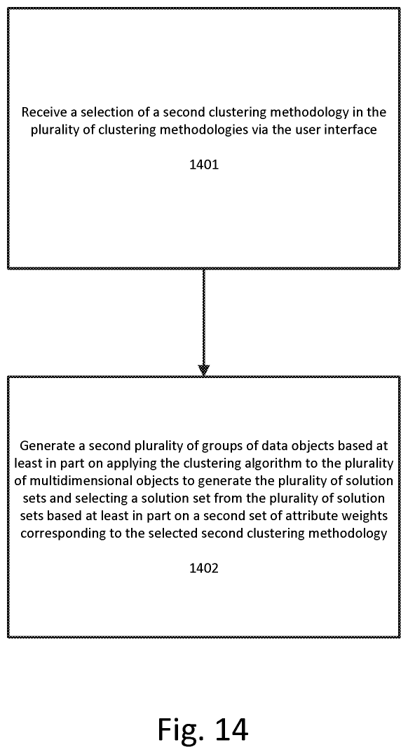

FIG. 14 illustrates a flowchart for generating groups using multiple clustering methodologies according to an exemplary embodiment. One or more of the steps shown in FIG. 14 can be performed after the steps shown in FIG. 9, in addition to the steps shown in FIG. 9, and/or as an alternative to one or more of the steps shown in FIG. 9.

At step 1401 a selection is received of a second clustering methodology in the plurality of clustering methodologies via the user interface. This selection can be received at the same time, or shortly after, selection of the initial clustering methodology (step 902 in FIG. 9), and prior to the actual clustering.

At step 1402 a second plurality of groups of data objects are generated based at least in part on applying the clustering algorithm to the plurality of multidimensional objects to generate the plurality of solution sets and selecting a solution set from the plurality of solution sets based at least in part on a second set of attribute weights corresponding to the selected second clustering methodology. This step allows for the re-generation of groups based on the second clustering methodology and the comparison of the generated groups from the second clustering methodology with the groups generated from the initial clustering methodology.

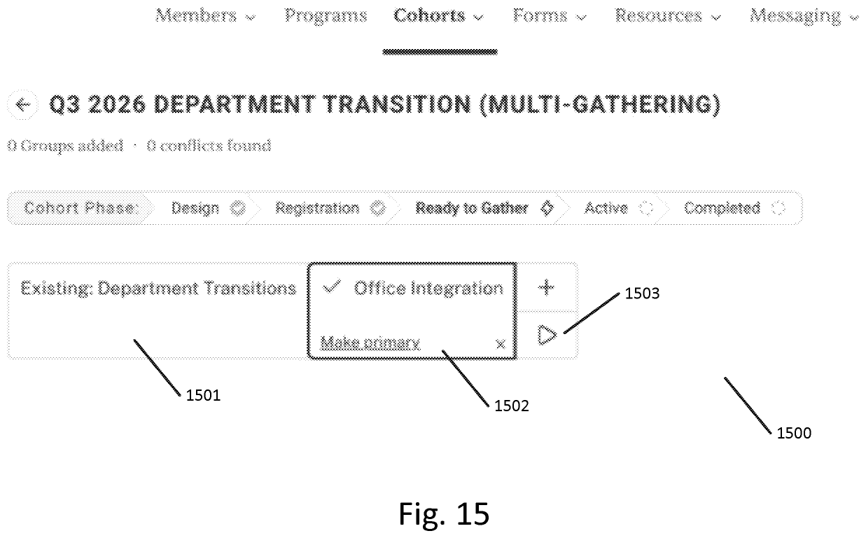

FIG. 15 illustrates an interface for selecting multiple clustering methodologies to generate groupings according to an exemplary embodiment. The interface 1500 refers to the selection of multiple clustering methodologies as “multi-gathering.” The initial clustering methodology 1501 that is selected is the “Department Transitions” methodology and the secondary clustering methodology 1502 that is selected is the “Office Integration” methodology. To utilize particular clustering methodology, the user can select the play button 1503 to initiate the clustering process. The resulting groups corresponding to the second clustering methodology can then be displayed in the interface 1500 and the first and second clustering methodologies can be directly compared (such as in an A/B test) by reviewing the generated groups from each clustering methodology.

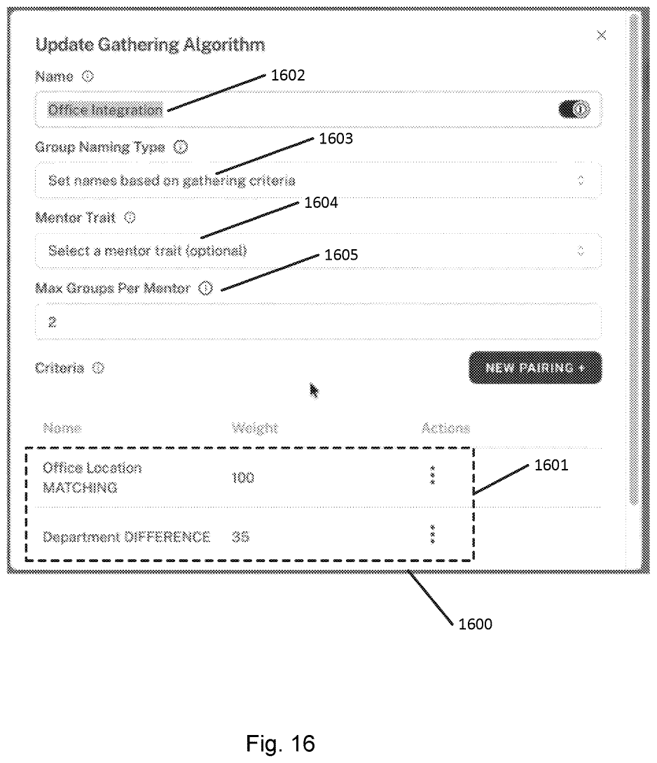

User can select from pre-existing clustering methodologies or customize or create their own clustering methodologies. FIG. 16 illustrates an interface 1600 for updating a gathering algorithm/clustering methodology according to an exemplary embodiment. As shown in FIG. 16, the methodology that is being customized is the Office Integration 1602 methodology. The interface 1600 includes a listing of attributes 1601 along with the corresponding weights for each of the attributes. In the example shown in FIG. 16, the attribute of office location matching (between persons/users) is given 100% weight, whereas the attribute of departments being different (between persons/users) is given 35% weight.

Gathering algorithms/clustering methodologies can be configured according to a variety if different attributes, attribute conditions, and attribute weightings. The attributes refer to the values of a particular feature for different members of a group. The attribute conditions refer to whether the attribute is matching or not matching between different persons or conditions such as nearest/closest attribute or farthest attribute. In other words, the attribute conditions specify the desired relationship between values of the attribute among different users in a proposed group. For example, in some algorithms it may be desirable to have a certain attribute matching (such as gender) and in other algorithms it may be desirable to have a certain attribute not matching (such as office location). The attribute weightings indicate a normalized weighting (e.g., 1-100) assigned to the attribute and condition when performing the clustering.

Some examples of attributes, attribute conditions, and attribute weightings are given below for an example gathering algorithm/clustering methodology used to generate groups of mid-level associates at a law firm (“mid-level associate gathering”):
Attribute: Office Location, Condition: Different, Weight: 10;
Attribute: Practice Group, Condition: Different, Weight: 40;
Attribute: Associate Level, Condition: Matching, Weight: 70;
Attribute: Racial/Ethnic Preference, Condition: Nearest, Weight: 30;
Attribute: First Generation, Condition: Nearest, Weight: 30;
Attribute: Law as Second Career Preference, Condition: Matching, Weight: 30;
Attribute: LGBTQ, Condition: Matching, Weight: 30;
Attribute: Neurodiversity Preference, Condition: Matching, Weight: 30;
Attribute: Work/Life Preference, Condition: Matching, Weight: 30; and
Attribute: Time Zone, Condition: Matching, Weight: 70.

As shown above, the attributes and conditions given the greatest weight are that Associate Levels of members in each group match (70 Weight) and the attribute and condition given the lowest weight is that Office Locations match (10 Weight). Attributes, attribute conditions, and attribute weights are utilized by the clustering algorithm when applying each clustering methodology to select a solution set generate the plurality of groups of data objects (corresponding to persons).

Users can specify a naming convention 1603 for the generated groups. In the example of FIG. 16, the groups are names based on gathering criteria, but the groups can also be named based on other criteria/factors, such as the names of persons in the group. This convention can be utilized for mentor/mentee groupings, for example. Additionally, for mentoring gathering algorithms (i.e., a subset of the clustering/gathering algorithms), a mentor trait 1604 can be set, which is a trait that is required for a mentor in each group. The user can also specify the number of mentees that each mentor can have, designated as max groups per mentor 1605.

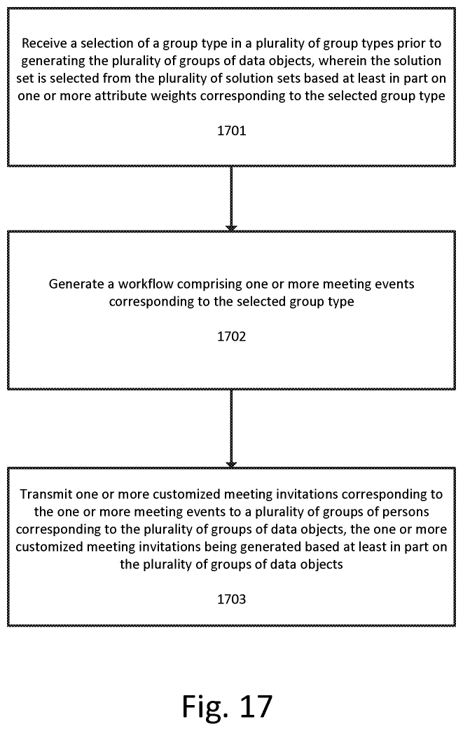

The quantitative grouping process disclosed herein can be used not only to generating groupings, but also to generate and execute customized workflows linked to the specific types of groups generated. FIG. 17 illustrates a flowchart for generating and executing group-specific workflows according to an exemplary embodiment.

At step 1701 a selection of a group type in a plurality of group types is received prior to generating the plurality of groups of data objects. Each group type can have its own associated attribute weights and attributes used to perform the groupings and the solution set can be selected from the plurality of solution sets based at least in part on one or more attribute weights corresponding to the selected group type and/or attributes corresponding to the selected group type.

At step 1702 a workflow is generated including one or more meeting events corresponding to the selected group type. The workflow can include group-specific events that are customized or specialized to the selected group type. For example, a mentor-mentee grouping can have monthly check-ins automatically scheduled, and employee practice group grouping can have quarterly zoom meetings scheduled, and other types of groupings can have different types of events scheduled, such as a gatherings, conferences, meetings, interviews, assignments, etc.

At step 1703 one or more customized meeting invitations are transmitted corresponding to the one or more meeting events to a plurality of groups of persons corresponding to the plurality of groups of data objects, the one or more customized meeting invitations being generated based at least in part on the plurality of groups of data objects. The customized meeting invitations can be generated based on the email addresses or contact information of the persons that are stored in the plurality of groups of data objects. For example, this step can retrieve contact information and email addresses of groups of people and then send out groups of invitations corresponding to the groups of people.

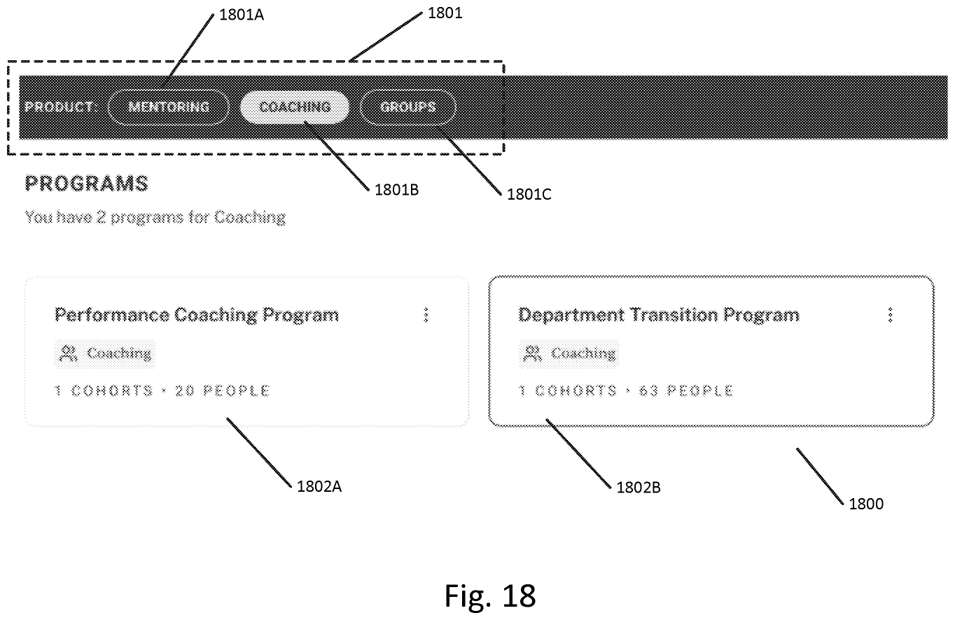

FIG. 18 illustrates an interface for selecting a group type and program according to an exemplary embodiment. Interface 1800 allows user to select a group type, as shown in box 1801. The group types include a mentoring group type 1801A, a coaching group type 1801B, and a general group type 1801C. Each of these groups types can have their own associated attributes and attribute weight that are utilized to select the optimal solution set during the clustering process.

Each group type can also have different default clustering methodologies/gathering algorithms. For example, the mentoring group types can have different default or available gathering algorithms/clustering methodologies than the coaching group types. If certain traits in a gathering algorithm are associated with mentoring, then the algorithm can be classified as a mentoring algorithm.

Within each group type, the platform can include different programs that serve as variants of the group type. In the example of FIG. 18, the coaching group type 1801B includes the “Performance Coaching Program” 1802A and the Department Transition Program 1802B. Each of these programs can have their own associated attributes and/or attribute weights.

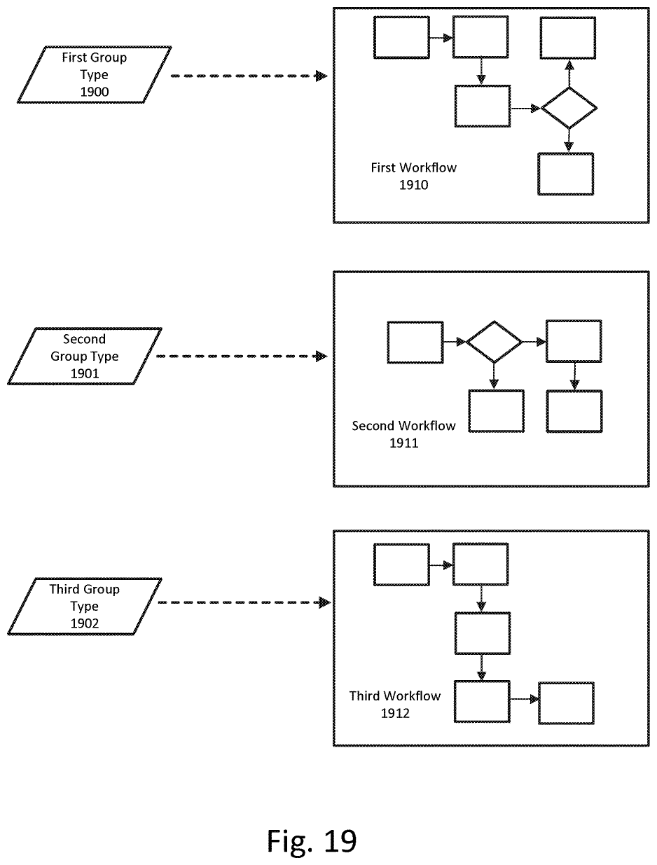

Different group types can have different associated workflows that are executed for group members after the groups are generated. FIG. 19 illustrates an example of group types and associated workflows according to an exemplary embodiment. As shown in FIG. 19, the first group type 1900 has an associated first workflow 1910, the second group type 1901 has an associated second workflow 1911, and the third group type 1902 has an associated third workflow 1912. As discussed previously, the workflows can include various events associated with each group type.

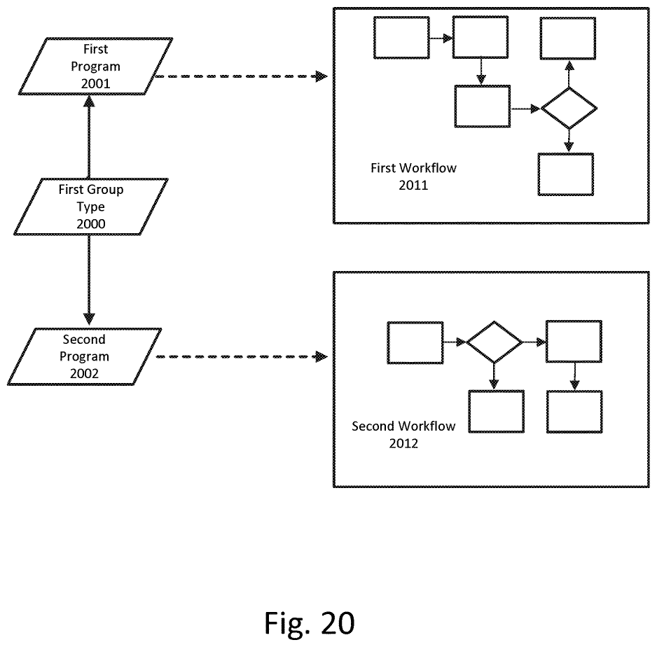

FIG. 20 illustrates an example of program types and associated workflows according to an exemplary embodiment. The first group type 2000 can include a first program 2001 variant and a second program 2002 variant. The first program 2001 variant can have an associated first workflow 2011 and the second program 2002 variant can have an associated second workflow 2012. In this example, different program variants within a group type have differing workflows.

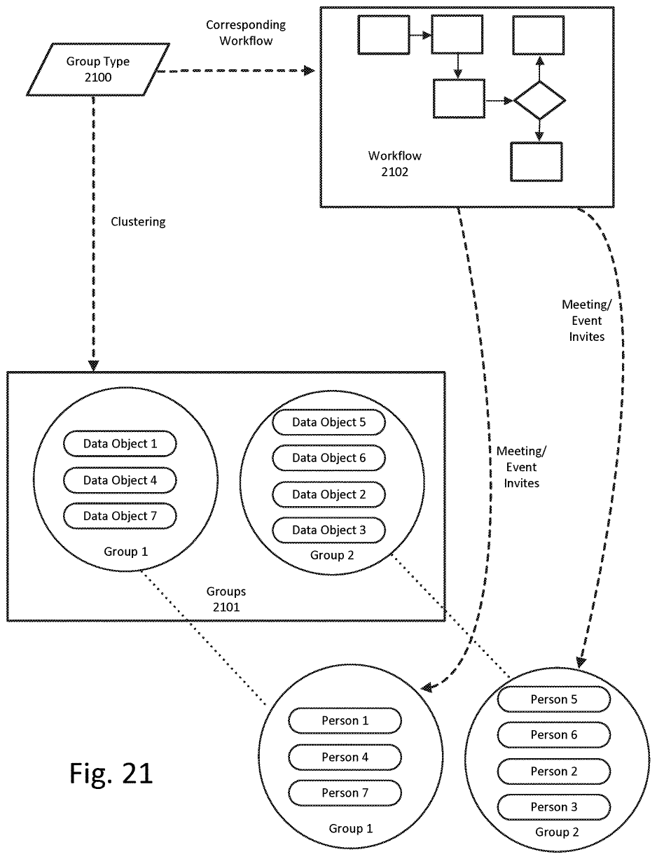

FIG. 21 illustrates a system chart of the clustering and corresponding workflow execution process according to an exemplary embodiment. Group type 2100 has corresponding associated workflow 2102. When clustering is performed for group type 2100, the resulting groups 2101 include Group 1 (with data objects 1, 4, and 7) and Group 2 (with data objects 2, 3, 5, and 6). After generation of groups 2101, the corresponding workflow 2102 is used to identify meetings/events and send meeting/event invites to the persons corresponding to Group 1 (Persons 1, 4, and 7) and Group 2 (Persons 2, 3, 5, and 6).

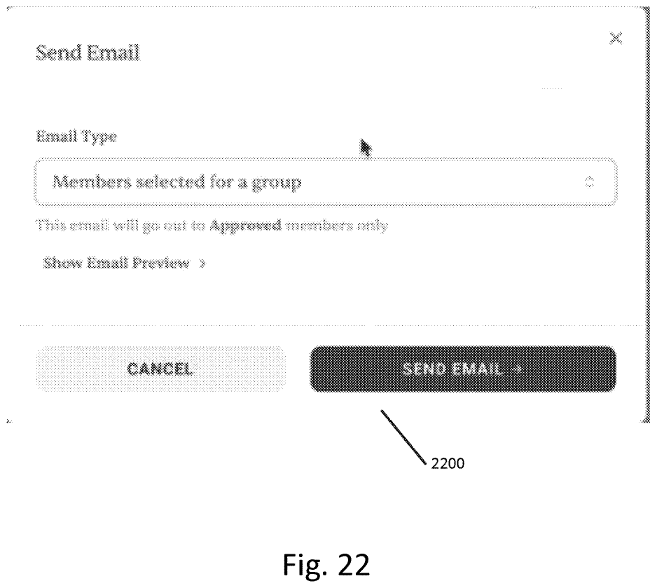

FIG. 22 illustrates an example of a group-specific notification interface according to an exemplary embodiment. The interface 2200 allows administrators to define an email communication/message to be sent to members of one or more groups after the clustering process is completed and groups are generated. This email message can be part of the workflow corresponding to specific group types or program variants.

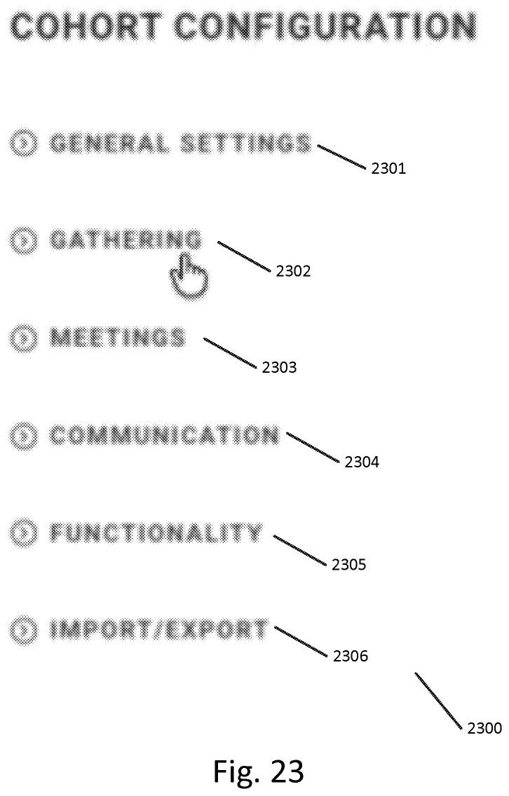

FIG. 23 illustrates an interface with different types of events/actions that can be preconfigured for group types according to an exemplary embodiment. As shown in FIG. 23, interface 2300 includes configuration options for general settings 2301, gathering algorithm 2302, meetings 2303, communication 2304, functionality 2305, and import/export features 2306. The general settings 2301 can include user/admin preferences, passwords, accounts, and other settings. The gathering settings 2302 are discussed earlier and relate to the specific clustering methodologies utilized and the settings for the clustering methodologies, including attributes and attribute weights. The meetings settings 2303 allow users define meetings associated with different group types, and can include options to manage meetings, reminder settings for meetings, and meeting agenda configurations and settings. The communication settings 2304 can be used to configure sending emails to group members, sending calendar invites, updating calendar invites with email information, updating calendar events duration/description, sending out coach introductions, coaching reporting questions, coach introduction settings, and assignment of forms to groups/members with a particular cohort. Functionality settings 2305 allow admins/users to add new groups/cohorts, edit cohorts, delete cohorts, adding members, or manually moving members between groups. Functionality settings 2305 can also allow users to lock cohorts/groups so that they cannot be reassigned/reprocessed. Additionally, import/export settings 2306 allow for the importation of data into the clustering platform for use in the clustering process and the export of data (such as group data or other clustering information) to other platforms, users, or systems. As explained above, the various settings allow users to define communications, emails, meetings, calendar invites (including emails, duration, descriptions), coach introductions, coach report questions, and/or forms to be sent to group members. All of these events can be defined in workflows corresponding to different group types.

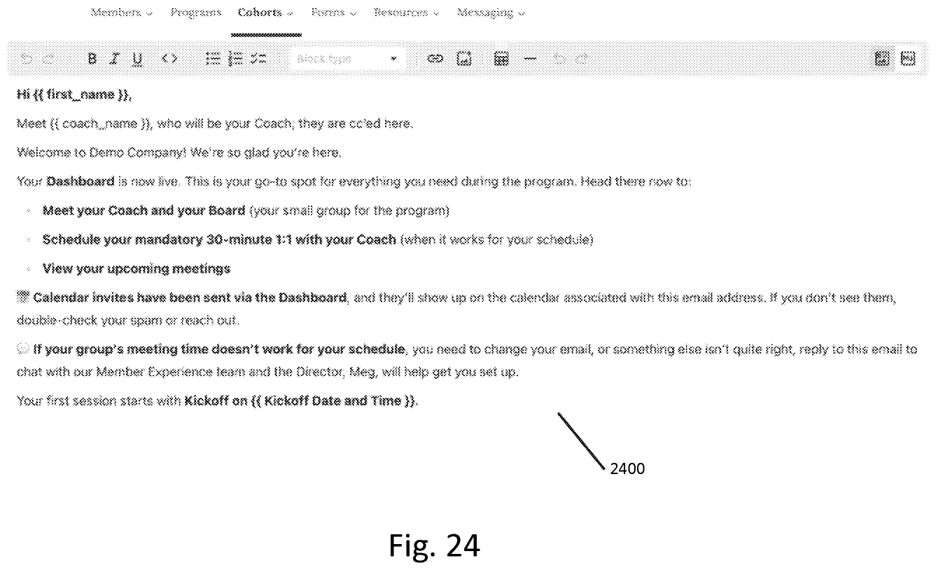

FIG. 24 illustrates an interface showing an example of template message to be sent to group members according to an exemplary embodiment. The example shown in interface 2400 is a coach introduction message that can be sent to group members after groups are formed. As shown in interface 2400, an administrator/user can customize the message and insert references to objects that will be populated after the clustering/grouping is performed. This includes names of members of each group, coaches assigned to each group, or specific dates and types associated with group types and corresponding workflows. The generated template, such as the one shown in FIG. 24, can be customized and instantiated multiple times for each person and each group of persons.

The grouping platform can continue to track groups and persons within groups throughout the various steps of group workflows, even after initial generation of the groups. This can include determining and tracking various insights corresponding to specific persons and specific meeting events.

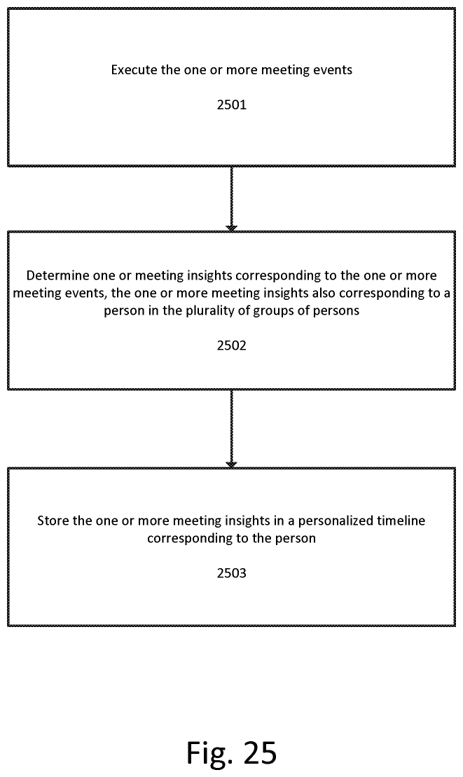

FIG. 25 illustrates a flowchart for tracking insights in groups according to an exemplary embodiment. At step 2501 the one or more meeting events are executed. This can include, for example, an online meeting, conference, or other event. At step 2502 one or meeting insights corresponding to the one or more meeting events are determined, the one or more meeting insights also corresponding to a person in the plurality of groups of persons. The meeting insights can be determined by the system, indicated by an administrator or group member, or otherwise detected and/or determined. At step 2503 the one or more meeting insights are stored in a personalized timeline corresponding to the person. Each person can have their own profile including the various groups that they belong to, as well as their personal insights for each group. The insights can include information about the relevant meeting, the relevant group, any other relevant details. Insights can be gathered, for example, via exit surveys implemented as part of events and meetings.

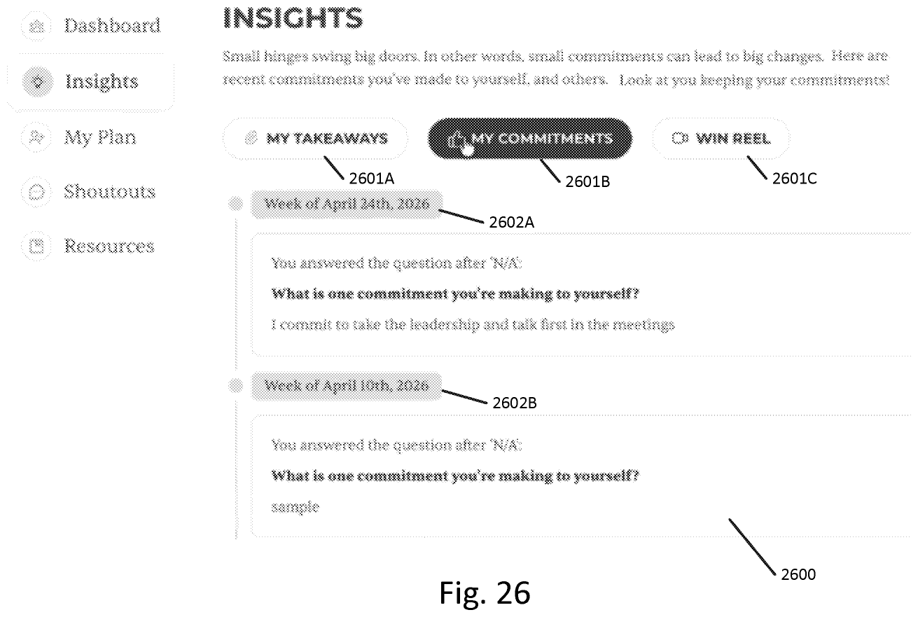

FIG. 26 illustrates an interface for viewing insights according to an exemplary embodiment. The interface 2600 is an interface corresponding to a particular user and can be accessed via a personal portal and login. The interface 2600 includes different types of insights that are tracked, including “my takeaways” 2601A, “my commitments” 2601B, and a “win reel” 2601C. My takeaways 2601A can include, for example, notes or insights created by a user regarding lessons or goals of particular meetings. My commitments 2601B can include specific requirements or obligations taken on by the user. The commitments can be tasked by the user, by a group coach, by another member, and/or automatically assigned during the meeting. The win reel 2601C can include accomplishments of the user/person during a meeting, compliments or praise of the person in a meeting or subsequent to a meeting, or other achievements associated with a particular group member/person. As shown in FIG. 26, the interface 2600 can include insights partitioned according to different meetings, such as meeting 2602A and meeting 2602B.

The grouping platform can simultaneously generate groupings and at the same time flag/identify potential conflicts within generated groupings. For example, it may be that the best overall solution for groupings requires the creation of one or two groups where pairs of group members have some potential conflicts or conflicting attributes. These conflicts can be presented to users/administrators when the groups are created. Optionally, the user/administrator can be required to approve the conflicts to enable generation of the determined groups and execution of corresponding workflows.

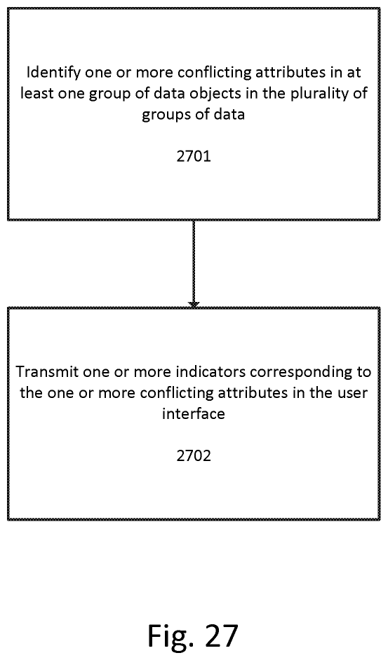

FIG. 27 illustrates a flowchart for identifying intra-group conflicts according to an exemplary embodiment. At step 2701 one or more conflicting attributes in at least one group of data objects in the plurality of groups of data are identified. Conflicting attributes can include attributes that do not match and have some associated weighting under the relevant group type, clustering methodology. For example, some group members in one group of an optimal grouping solution can have locations that do not align, despite the overall solution being the best solution for a particular clustering methodology.

At step 2702 one or more indicators corresponding to the one or more conflicting attributes are transmitted in the user interface. The indicators can be transmitted in a review interface after the groups are generated but prior to finalization of groups. User/administrator can then review the conflicts/groups and determine whether the corresponding conflicting attributes are acceptable. If the conflicts are acceptable, then the user can accept the conflicts, and the groups can be finalized.

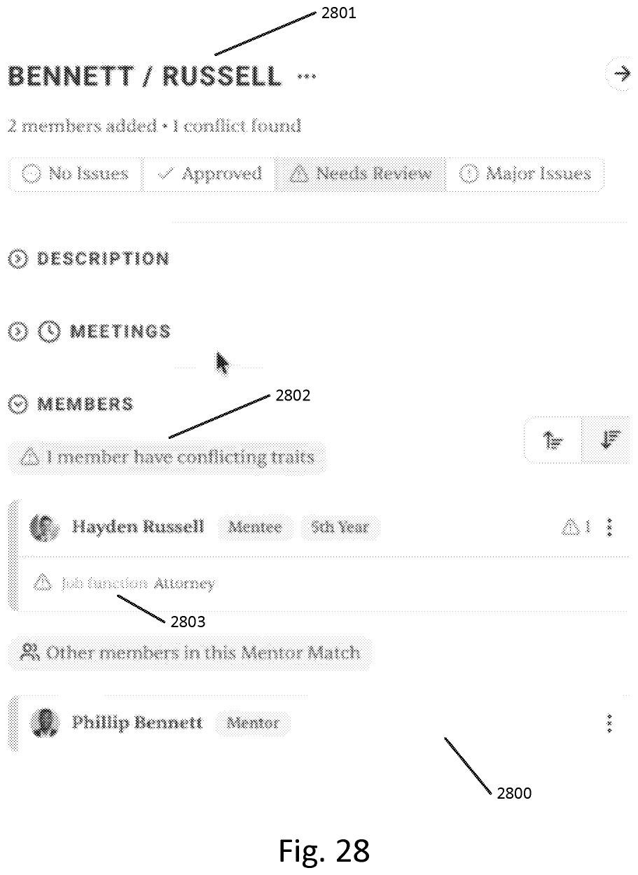

FIG. 28 illustrates an interface for displaying conflicts according to an exemplary embodiment. As shown in FIG. 28, interface 2800 for mentor/mentee grouping “Bennett/Russell” includes one member having conflicting traits, as indicated at 2802. Specifically, the job function 2803 of one of the group members (Hayden Russell) appears to conflict with either another group member, a specific role, or some other attribute. If this conflict will not impact the group or effect the overall purpose of the group, then the user/administrators can accept/ignore the conflict and the system will then proceed with finalizations of the groups.

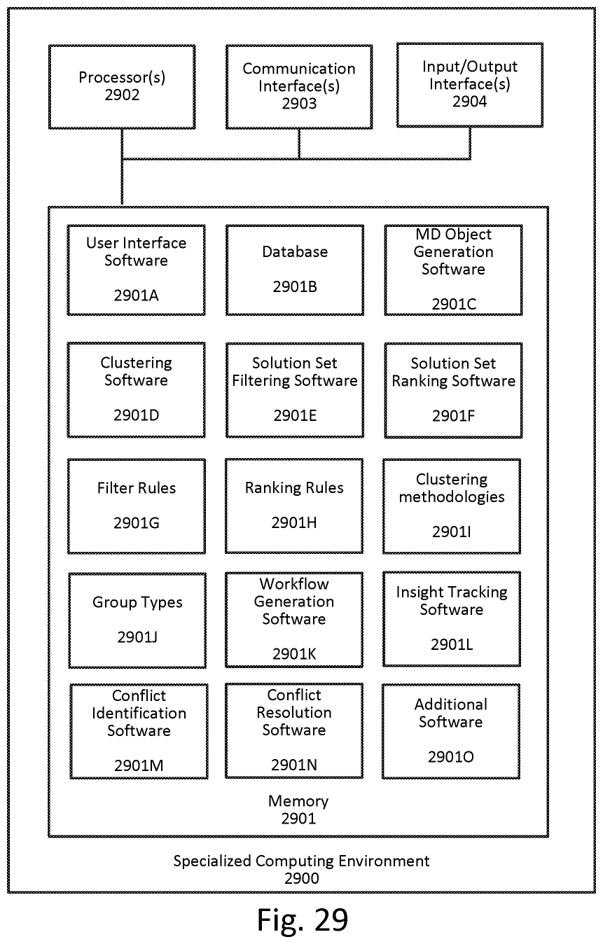

FIG. 29 illustrates the components of the specialized computing environment 900 configured to perform the specialized processes described herein. Specialized computing environment 2900 is a computing device that includes a memory 2901 that is a non-transitory computer-readable medium and can be volatile memory (e.g., registers, cache, RAM), non-volatile memory (e.g., ROM, EEPROM, flash memory, etc.), or some combination of the two.

As shown in FIG. 29, memory 2901 can include user interface software 2901A, a database 2901B that stores the data objects, plurality of attributes, MD objects, generated clusters, solution sets, and all other intermediate data generated by the processes described herein, MD object generation software 2901C, clustering software 2901D, solution set filtering software 2901E, solution set ranking software 2901F, filter rules 2901G, ranking rules 2901H, clustering methodologies 2901I, group types 2901J, workflow generation software 2901K, insight tracking software 2901L, conflict identification software 2901M, conflict resolution software 2901N, and/or additional software 2901O required to implement the specialized processes described herein. Each of the software components in memory 2901 store specialized instructions and data structures configured to perform the corresponding functionality and techniques described herein.

All of the software stored within memory 2901 can be stored as a computer-readable instructions, that when executed by one or more processors 2902, cause the processors to perform the functionality described with respect to FIGS. 1-28.

Processor(s) 2902 execute computer-executable instructions and can be a real or virtual processors. In a multi-processing system, multiple processors or multicore processors can be used to execute computer-executable instructions to increase processing power and/or to execute certain software in parallel.

Specialized computing environment 2900 additionally includes a communication interface 2903, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 2900 further includes input and output interfaces 2904 that allow users (such as system administrators) to provide input to the system to set parameters, to edit data stored in memory 2901, or to perform other administrative functions.

An interconnection mechanism (shown as a solid line in FIG. 29), such as a bus, controller, or network interconnects the components of the specialized computing environment 900.

Input and output interfaces 2904 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 2900.

Specialized computing environment 2900 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 2900.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Elements of the described embodiment shown in software may be implemented in hardware and vice versa.

It will be appreciated by those skilled in the art that changes could be made to the embodiments described above without departing from the broad inventive concept thereof. For example, the steps or order of operation of one of the above-described methods could be rearranged or occur in a different series, as understood by those skilled in the art. It is understood, therefore, that this disclosure is not limited to the particular embodiments disclosed, but it is intended to cover modifications within the spirit and scope of the present disclosure as defined by the appended claims.

1. A method executed by one or more computing devices for quantitatively grouping a set of persons into a plurality of groups using computational clustering, the method comprising:
storing, by at least one of the one or more computing devices, a set of data objects corresponding to the set of persons and a plurality of attributes corresponding to each data object in the set of data objects;
receiving, by at least one of the one or more computing devices, a selection of a clustering methodology in a plurality of clustering methodologies via a user interface, each clustering methodology having a corresponding set of attribute weights corresponding to the plurality of attributes;
generating, by at least one of the one or more computing devices, a plurality of multidimensional objects by encoding each data object in the set of data objects as a multidimensional object based at least in part on two or more attributes corresponding to that data object, each multidimensional object corresponding to a data object in the set of data objects; and
generating, by at least one of the one or more computing devices, a plurality of groups of data objects based at least in part on applying a clustering algorithm to the plurality of multidimensional objects to generate a plurality of solution sets and selecting a solution set from the plurality of solution sets based at least in part on the set of attribute weights corresponding to the selected clustering methodology.

2. The method of claim 1, wherein generating a plurality of groups of data objects based at least in part on applying a clustering algorithm to the plurality of multidimensional objects to generate a plurality solution sets and selecting a solution set from the plurality of solution sets based at least in part on the set of attribute weights corresponding to the selected clustering methodology comprises:
applying the clustering algorithm to the plurality of multidimensional objects to generate the plurality of solution sets, each solution set comprising a plurality of clusters of multidimensional objects, each cluster of multidimensional objects comprising a plurality of multidimensional objects;
removing one or more solution sets from the plurality of solution sets to generate a filtered plurality of solution sets based at least in part on one or more attributes of one or more data objects corresponding to one or more multidimensional objects in one or more clusters of each removed solution set;
selecting a solution set from the filtered plurality of solution sets based at least in part on the set of attribute weights corresponding to the selected clustering methodology; and
grouping the plurality of data objects according to the plurality of clusters defined in the selected solution set.

3. The method of claim 1, further comprising:
receiving, by at least one of the one or more computing devices, a selection of a second clustering methodology in the plurality of clustering methodologies via the user interface; and
generating, by at least one of the one or more computing devices, a second plurality of groups of data objects based at least in part on applying the clustering algorithm to the plurality of multidimensional objects to generate the plurality of solution sets and selecting a solution set from the plurality of solution sets based at least in part on a second set of attribute weights corresponding to the selected second clustering methodology.

4. The method of claim 1, further comprising:
receiving, by at least one of the one or more computing devices, a selection of a group type in a plurality of group types prior to generating the plurality of groups of data objects, wherein the solution set is selected from the plurality of solution sets based at least in part on one or more attribute weights corresponding to the selected group type;
generating, by at least one of the one or more computing devices, a workflow comprising one or more meeting events corresponding to the selected group type; and
transmitting, by at least one of the one or more computing devices, one or more customized meeting invitations corresponding to the one or more meeting events to a plurality of groups of persons corresponding to the plurality of groups of data objects, the one or more customized meeting invitations being generated based at least in part on the plurality of groups of data objects.

5. The method of claim 4, further comprising:
executing, by at least one of the one or more computing devices, the one or more meeting events;
determining, by at least one of the one or more computing devices, one or meeting insights corresponding to the one or more meeting events, the one or more meeting insights also corresponding to a person in the plurality of groups of persons; and
storing, by at least one of the one or more computing devices, the one or more meeting insights in a personalized timeline corresponding to the person.

6. The method of claim 1, further comprising:
identifying, by at least one of the one or more computing devices, one or more conflicting attributes in at least one group of data objects in the plurality of groups of data; and
transmitting, by at least one of the one or more computing devices, one or more indicators corresponding to the one or more conflicting attributes in the user interface.

7. An apparatus for quantitatively grouping a set of persons into a plurality of groups using computational clustering, the apparatus comprising:
one or more processors; and
one or more memories operatively coupled to at least one of the one or more processors and having instructions stored thereon that, when executed by at least one of the one or more processors, cause at least one of the one or more processors to:
store a set of data objects corresponding to the set of persons and a plurality of attributes corresponding to each data object in the set of data objects;
receive a selection of a clustering methodology in a plurality of clustering methodologies via a user interface, each clustering methodology having a corresponding set of attribute weights corresponding to the plurality of attributes;
generate a plurality of multidimensional objects by encoding each data object in the set of data objects as a multidimensional object based at least in part on two or more attributes corresponding to that data object, each multidimensional object corresponding to a data object in the set of data objects; and
generate a plurality of groups of data objects based at least in part on applying a clustering algorithm to the plurality of multidimensional objects to generate a plurality of solution sets and selecting a solution set from the plurality of solution sets based at least in part on the set of attribute weights corresponding to the selected clustering methodology.

8. The apparatus of claim 7, wherein the instructions that, when executed by at least one of the one or more processors, cause at least one of the one or more processors to generate a plurality of groups of data objects based at least in part on applying a clustering algorithm to the plurality of multidimensional objects to generate a plurality solution sets and selecting a solution set from the plurality of solution sets based at least in part on the set of attribute weights corresponding to the selected clustering methodology further cause at least one of the one or more processors to:
apply the clustering algorithm to the plurality of multidimensional objects to generate the plurality of solution sets, each solution set comprising a plurality of clusters of multidimensional objects, each cluster of multidimensional objects comprising a plurality of multidimensional objects;
remove one or more solution sets from the plurality of solution sets to generate a filtered plurality of solution sets based at least in part on one or more attributes of one or more data objects corresponding to one or more multidimensional objects in one or more clusters of each removed solution set;
select a solution set from the filtered plurality of solution sets based at least in part on the set of attribute weights corresponding to the selected clustering methodology; and
group the plurality of data objects according to the plurality of clusters defined in the selected solution set.

9. The apparatus of claim 7, wherein at least one of the one or more memories has further instructions stored thereon that, when executed by at least one of the one or more processors, cause at least one of the one or more processors to:
receive a selection of a second clustering methodology in the plurality of clustering methodologies via the user interface; and
generate a second plurality of groups of data objects based at least in part on applying the clustering algorithm to the plurality of multidimensional objects to generate the plurality of solution sets and selecting a solution set from the plurality of solution sets based at least in part on a second set of attribute weights corresponding to the selected second clustering methodology.

10. The apparatus of claim 7, wherein at least one of the one or more memories has further instructions stored thereon that, when executed by at least one of the one or more processors, cause at least one of the one or more processors to:
receive a selection of a group type in a plurality of group types prior to generating the plurality of groups of data objects, wherein the solution set is selected from the plurality of solution sets based at least in part on one or more attribute weights corresponding to the selected group type;
generate a workflow comprising one or more meeting events corresponding to the selected group type; and
transmit one or more customized meeting invitations corresponding to the one or more meeting events to a plurality of groups of persons corresponding to the plurality of groups of data objects, the one or more customized meeting invitations being generated based at least in part on the plurality of groups of data objects.

11. The apparatus of claim 10, wherein at least one of the one or more memories has further instructions stored thereon that, when executed by at least one of the one or more processors, cause at least one of the one or more processors to:
execute the one or more meeting events;
determine one or meeting insights corresponding to the one or more meeting events, the one or more meeting insights also corresponding to a person in the plurality of groups of persons; and
store the one or more meeting insights in a personalized timeline corresponding to the person.

12. The apparatus of claim 7, wherein at least one of the one or more memories has further instructions stored thereon that, when executed by at least one of the one or more processors, cause at least one of the one or more processors to:
identify one or more conflicting attributes in at least one group of data objects in the plurality of groups of data; and
transmit one or more indicators corresponding to the one or more conflicting attributes in the user interface.

13. At least one non-transitory computer-readable medium storing computer-readable instructions for quantitatively grouping a set of persons into a plurality of groups using computational clustering that, when executed by one or more computing devices, cause at least one of the one or more computing devices to:
store a set of data objects corresponding to the set of persons and a plurality of attributes corresponding to each data object in the set of data objects;
receive a selection of a clustering methodology in a plurality of clustering methodologies via a user interface, each clustering methodology having a corresponding set of attribute weights corresponding to the plurality of attributes;
generate a plurality of multidimensional objects by encoding each data object in the set of data objects as a multidimensional object based at least in part on two or more attributes corresponding to that data object, each multidimensional object corresponding to a data object in the set of data objects; and
generate a plurality of groups of data objects based at least in part on applying a clustering algorithm to the plurality of multidimensional objects to generate a plurality of solution sets and selecting a solution set from the plurality of solution sets based at least in part on the set of attribute weights corresponding to the selected clustering methodology.

14. The at least one non-transitory computer-readable medium of claim 13, wherein the instructions that, when executed by at least one of the one or more processors, cause at least one of the one or more processors to generate a plurality of groups of data objects based at least in part on applying a clustering algorithm to the plurality of multidimensional objects to generate a plurality solution sets and selecting a solution set from the plurality of solution sets based at least in part on the set of attribute weights corresponding to the selected clustering methodology further cause at least one of the one or more processors to:
apply the clustering algorithm to the plurality of multidimensional objects to generate the plurality of solution sets, each solution set comprising a plurality of clusters of multidimensional objects, each cluster of multidimensional objects comprising a plurality of multidimensional objects;
remove one or more solution sets from the plurality of solution sets to generate a filtered plurality of solution sets based at least in part on one or more attributes of one or more data objects corresponding to one or more multidimensional objects in one or more clusters of each removed solution set;
select a solution set from the filtered plurality of solution sets based at least in part on the set of attribute weights corresponding to the selected clustering methodology; and
group the plurality of data objects according to the plurality of clusters defined in the selected solution set.

15. The at least one non-transitory computer-readable medium of claim 13, further storing computer-readable instructions that, when executed by at least one of the one or more computing devices, cause at least one of the one or more computing devices to:
receive a selection of a second clustering methodology in the plurality of clustering methodologies via the user interface; and
generate a second plurality of groups of data objects based at least in part on applying the clustering algorithm to the plurality of multidimensional objects to generate the plurality of solution sets and selecting a solution set from the plurality of solution sets based at least in part on a second set of attribute weights corresponding to the selected second clustering methodology.

16. The at least one non-transitory computer-readable medium of claim 13, further storing computer-readable instructions that, when executed by at least one of the one or more computing devices, cause at least one of the one or more computing devices to:
receive a selection of a group type in a plurality of group types prior to generating the plurality of groups of data objects, wherein the solution set is selected from the plurality of solution sets based at least in part on one or more attribute weights corresponding to the selected group type;
generate a workflow comprising one or more meeting events corresponding to the selected group type; and
transmit one or more customized meeting invitations corresponding to the one or more meeting events to a plurality of groups of persons corresponding to the plurality of groups of data objects, the one or more customized meeting invitations being generated based at least in part on the plurality of groups of data objects.

17. The at least one non-transitory computer-readable medium of claim 16, further storing computer-readable instructions that, when executed by at least one of the one or more computing devices, cause at least one of the one or more computing devices to:
execute the one or more meeting events;
determine one or meeting insights corresponding to the one or more meeting events, the one or more meeting insights also corresponding to a person in the plurality of groups of persons; and
store the one or more meeting insights in a personalized timeline corresponding to the person.

18. The at least one non-transitory computer-readable medium of claim 13, further storing computer-readable instructions that, when executed by at least one of the one or more computing devices, cause at least one of the one or more computing devices to:
identify one or more conflicting attributes in at least one group of data objects in the plurality of groups of data; and
transmit one or more indicators corresponding to the one or more conflicting attributes in the user interface.
